(19) United States
(12) Patent Application Publication
(10) Pub. No.: US 2012/0299919 A1
(43) Pub. Date: Nov. 29, 2012

(54) IMAGE DISPLAY DEVICE

(75) Inventor: Satoshi Sakurai, Tokyo (JP)

(73) Assignee: Mitsubishi Electric Corporation, Tokyo (JP)

(21) Appl. No.: 13/575,355

(22) PCT Filed: Feb. 23, 2010
(86) PCT No.: PCT/JP10/01207

§ 371 Date: Jul. 26, 2012

(51) Int. Cl. G06T 17/00

(52) U.S. Cl. 345/420

(57) ABSTRACT

An image display device including a data expanding unit for reading divided data specified by a read command from among plural divided data stored in an HDD and expanding the divided data in a memory from and in which data can be read and written at a higher speed than data are read and written from and in the HDD, a degree of detail determining unit for determining the degree of detail of drawing of each of the polygon models in consideration of a point of view in a virtual space, and a polygon model constructing unit for referring to the divided data expanded in the memory and constructing a polygon model having vertices whose number corresponds to the degree of detail, and for outputting a read command specifying divided data to be read to the data expanding unit.

### FIELD OF THE INVENTION

The present invention relates to an image display device which uses three-dimensional geometrical information to display an image.

### BACKGROUND OF THE INVENTION

A display device needs to display an image in real time to present the image to the user in order to construct an interactive application by using computer graphics. As the image which is presented to the user, in addition to an image recorded in a computer, there is provided a processed image into which the image recorded in the computer is processed by the computer or an image internally drawn by the computer using recorded information.

Particularly, in order to construct an environment (a virtual environment) in which a virtual object is placed in a three-dimensional virtual space in a computer, and cause the computer to draw and display a virtual environment which is viewed from a virtual viewpoint, the computer needs to use many pieces of information including the three-dimensional geometric shape, colors, and so on of the virtual environment to carry out complicated processes including a projecting process in real time. However, when the environment drawn is complicated and when the processing performance of the computer is not high, it is difficult for the computer to carry out the above-mentioned processes in real time. Although there are various data formats expressing a three-dimensional virtual space in the computer, it is assumed hereafter that a virtual object and an environment which are targets to be drawn consist of triangular polygons each expressed by a surface on which three points located at different positions in a virtual space are connected to each other.

A conventional image display device uses an LOD (Level Of Detail) technique when drawing a complicated three-dimensional virtual environment at a high speed. The LOD technique is intended for shortening the drawing time required to draw a three-dimensional virtual environment which is a target to be drawn by reducing or simplifying a part of information showing the three-dimensional virtual environment.

For example, patent reference 1 shown below discloses the following LOD technique. First, an original polygon model showing an object to be display is simplified, a simplified polygon model is recorded in a secondary storage device together with the original polygon model. Next, when drawing an object to be displayed, a visual contribution of each model to the result of the drawing is predicted, and the original polygon model is loaded from the secondary storage device into a memory and is displayed for a model whose contribution is higher than a certain threshold. In contrast, for a model whose contribution is lower than the certain threshold, the simplified polygon model is loaded from the secondary storage device into the memory and is displayed, thereby reducing the amount of memory used for the drawing and the drawing time required to draw the object to be displayed.

In the case of properly selecting either the original polygon model or the simplified polygon model to draw the object to be displayed, the following malfunction may occur. For example, when a movement or the like of the point of view causes an interchange between the original polygon model and the simplified polygon model, a change in the polygon model appears remarkably and unnaturalness is noticeable if the shape of the original polygon model differs greatly from that of the simplified polygon model.

Although the above-mentioned unnaturalness can be reduced by setting the threshold associated with the contribution at the time of selecting either the original polygon model or the simplified polygon model to a higher value, speeding up the drawing and reducing the used memory amount are weakened because the frequency with which to use the original polygon model increases. Further, while the above-mentioned unnaturalness can be reduced by recording a plurality of polygon models having different levels of simplification in the secondary storage device, and making an interchange among the plurality of polygon models according to a plurality of thresholds, the data volume of the plurality of polygon models recorded in the secondary storage device increases greatly. The frequency of access to the secondary storage device also increases greatly, and a bottleneck occurs.

Nonpatent reference 1 shown below discloses View-Dependent Progressive Mesh as another LOD technique different from the LOD technique disclosed by patent reference 1. According to View-Dependent Progressive Mesh, at the same time when the number of polygons each having a small visual contribution to the drawing result, which are included in a polygon model which is a target to be drawn, is reduced, a part of remaining polygons is deformed in such a way that the influence of the reduction of the number of such polygons which is imposed on the drawing result is reduced. As a result, the processing time required to draw the polygon model can be shortened while maintaining the quality of the image which is the drawing result. Further, because deletion of a polygon and restoration of a polygon deleted can be carried out in units of a vertex, the polygon mode can be always drawn with a necessary minimum number of polygons. It is further possible to bring a deformation caused in the target to be drawn due to a change of the number of polygons into non-prominence.

However, in the case of View-Dependent Progressive Mesh, in addition to model information about the polygon model which is a target to be drawn, it is necessary to record information required for a dynamic change in the number of polygons in a storage unit, such as a memory, from which data can be read at a high speed. Because a typical computer has a storage unit of relatively small capacity from and in which data can be read and written at a high speed, it is difficult to record all of the model information about the polygon model and all of the information needed for a dynamic change in the number of polygons in the storage unit when the virtual environment has a large scale. Particularly, because a terminal having relatively low performance, such as embedded equipment, has a storage unit of further smaller capacity from and in which data can be read and written at a high speed, it is difficult to apply View-Dependent Progressive Mesh to a three-dimensional virtual environment having a large amount of information in the terminal.

### RELATED ART DOCUMENT

### Patent Reference

Patent reference 1: Japanese Unexamined Patent Application Publication No. 2004-213641

### Nonpatent Reference

Nonpatent reference 1: Hoppe, H., “View dependent refinement of progressive meshes,” Proc. of International Conference on Computer Graphics and Interactive Techniques, pp. 189-198, 1997.

### SUMMARY OF THE INVENTION

Because the conventional image display device is constructed as above, the drawing time can be shortened as long as the LOD technique of reducing or simplifying a part of information showing a three-dimensional virtual environment which is a target to be drawn is applied to the image display device. However, when the LOD technique is applied to the image display device, in order to remove the unnaturalness caused by a model change which occurs when an interchange between the original polygon model and the simplified polygon model is made, it is necessary to mount a storage unit from and in which a lot of data (e.g. information about a plurality of polygon models having different levels of simplification, information required for a dynamic change in the number of polygons, etc.) can be read and written at a high speed. A problem is therefore that there is a case in which the LOD technique cannot be applied to a device, such as embedded equipment or a typical computer, in which no storage unit from and in which a lot of data can be read and written at a high speed is mounted.

The present invention is made in order to solve the above-mentioned problem, and it is therefore an object of the present invention to provide an image display device which can draw a complicated three-dimensional virtual environment at a high speed and with a high degree of quality by applying an LOD technique to the image display device even though no storage unit from and in which a lot of data can be read and written at a high speed is mounted in the image display device.

In accordance with the present invention, there is provided an image display device including: a model dividing unit for dividing a polygon model expressing a three-dimensional object; a vertex data creating unit for, for each of polygon models into which the polygon model is divided by the model dividing unit, creating new vertices from existing vertices of one or more polygons which construct the polygon model in question to create vertex data in which a logical connection relation between vertices of one or more polygon models including the new vertices is expressed by a tree structure; a data storage unit for dividing the vertex data created by the vertex data creating unit into a plurality of divided data to store the plurality of divided data of the vertex data in a storage unit; a data expanding unit for reading divided data specified by a read command from among the plurality of divided data stored in the storage unit and expanding the divided data in a recording medium from and in which data can be read and written at a higher speed than data are read and written from and in the storage unit, and for discarding divided data specified by a discard command from the divided data expanded in the recording medium; a degree of detail determining unit for determining a degree of detail of drawing of each of the polygon models acquired by the model dividing unit in consideration of a point of view in a virtual space; and a polygon model constructing unit for referring to the divided data expanded in the recording medium and constructing a polygon model having a number of vertices whose number corresponds to the degree of detail determined by the degree of detail determining unit, and for outputting a read command specifying divided data to be read and a discard command specifying divided data to be discarded to the data expanding unit, in which a drawing unit draws the polygon model constructed by the polygon model constructing unit.

The image display device in accordance with the present invention includes the a model dividing unit for dividing a polygon model expressing a three-dimensional object, the vertex data creating unit for, for each of polygon models into which the polygon model is divided by the model dividing unit, creating new vertices from existing vertices of one or more polygons which construct the polygon model in question to create vertex data in which a logical connection relation between vertices of one or more polygon models including the new vertices is expressed by a tree structure, the data storage unit for dividing the vertex data created by the vertex data creating unit into a plurality of divided data to store the plurality of divided data of the vertex data in the storage unit, the data expanding unit for reading divided data specified by a read command from among the plurality of divided data stored in the storage unit and expanding the divided data in the recording medium from and in which data can be read and written at a higher speed than data are read and written from and in the storage unit, and for discarding divided data specified by a discard command from the divided data expanded in the recording medium, the degree of detail determining unit for determining the degree of detail of drawing of each of the polygon models acquired by the model dividing unit in consideration of the point of view in the virtual space, and the polygon model constructing unit for referring to the divided data expanded in the recording medium and constructing a polygon model having a number of vertices whose number corresponds to the degree of detail determined by the degree of detail determining unit, and for outputting a read command specifying divided data to be read and a discard command specifying divided data to be discarded to the data expanding unit, and the drawing unit draws the polygon model constructed by the polygon model constructing unit. Therefore, there is provided an advantage of being able to draw a complicated three-dimensional virtual environment at a high speed and with a high degree of quality by applying an LOD technique to the image display device even though no storage unit from and in which a lot of data can be read and written at a high speed is mounted in the image display device.

### BRIEF DESCRIPTION OF THE FIGURES

FIG. 1 is a block diagram showing an image display device in accordance with Embodiment 1 of the present invention;

FIG. 2 is an explanatory drawing showing an example of a polygon model, vertex data, and surface data;

FIG. 3 is an explanatory drawing showing an example of division of the polygon model which is carried out by a model dividing unit 11;

FIG. 4 is a flow chart showing processing carried out by a data creating unit 12 in a pre-processing unit 1.

FIG. 5 is an explanatory drawing showing a state in which a polygon model in units of a block varies as the processing carried out by the data creating unit 12 progresses;

FIG. 6 is an explanatory drawing showing vertex data and surface data which are created from the polygon model shown in FIG. 5(a);

FIG. 7 is an explanatory drawing showing a logical connection relation between vertices which varies as the processing carried out by the data creating unit 12 progresses;

FIG. 8 is an explanatory drawing showing the vertex data and the surface data on which an update processing of updating the vertex data and the surface data is carried out once by the data creating unit 12;

FIG. 9 is an explanatory drawing showing the surface data which have been processed by the data creating unit 12;

FIG. 10 is a flow chart showing processing carried out by a sorting unit 13 in the pre-processing unit 1;

FIG. 11(a) is an explanatory drawing showing a logical connection relation between the vertices whose vertex indices have not been updated yet by the sorting unit 13, FIG. 11(b) is an explanatory drawing showing a logical connection relation between the vertices whose vertex indices have been updated by the sorting unit 13, and FIG. 11(c) is an explanatory drawing showing a state in which the vertices are divided into three sets by the sorting unit 13;

FIG. 12 is an explanatory drawing showing an example of a data structure expressing the vertices having a tree structure shown in FIG. 11(c);

FIG. 13 is an explanatory drawing showing the surface data in which vertex indices (a vertex reference array) have been updated.

FIG. 14 is an explanatory drawing showing the surface data in which surface indices have been updated;

FIG. 15 is an explanatory drawing showing the vertex data in which surface indices showing related surfaces have been updated;

FIG. 16 is an explanatory drawing showing surface data into which the original surface data are converted by the sorting unit 13;

FIG. 17 is an explanatory drawing showing an example in which vertex data and surface data belonging to a set 1 are recorded in an HDD 2 as a file 1, vertex data and surface data belonging to a set 2 are recorded in the HDD 2 as a file 2, and vertex data and surface data belonging to a set 3 are recorded in the HDD 2 as a file 3;

FIG. 18 is an explanatory drawing explaining determination processing of determining a degree of detail of drawing which is carried out by a degree of detail determining unit 32;

FIG. 19 is a flow chart showing processing carried out by a polygon model constructing unit 33 in a run time processing unit 3;

FIG. 20 is an explanatory drawing showing the vertex data and the surface data belonging to the sets 1 and 2 expanded in a memory 4; and

FIG. 21 is a flow chart showing processing carried out by a drawing processing unit 34 in the run time processing unit 3.

### EMBODIMENTS OF THE INVENTION

Hereafter, in order to explain this invention in greater detail, the preferred embodiments of the present invention will be described with reference to the accompanying drawings. Embodiment 1.

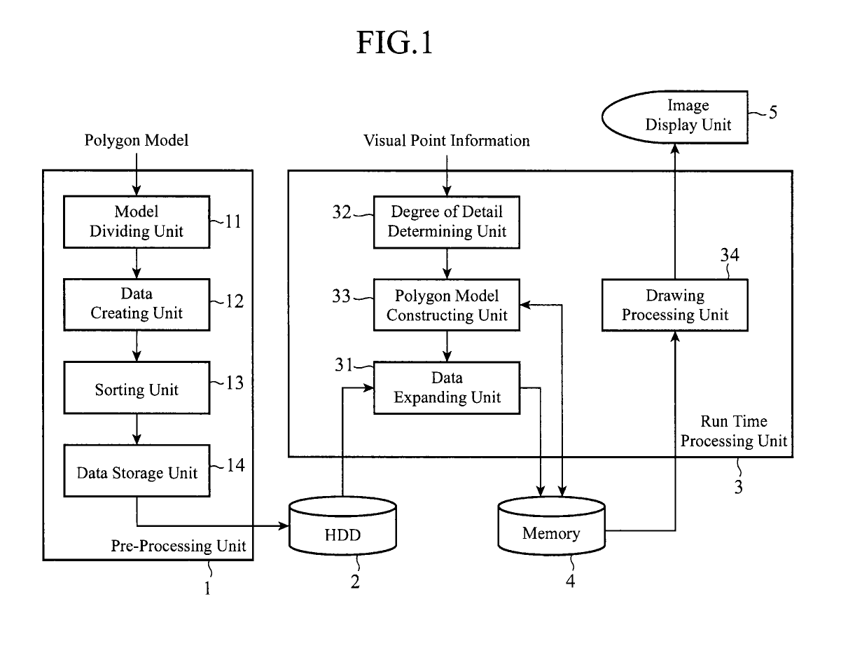

FIG. 1 is a block diagram showing an image display device in accordance with Embodiment 1 of the present invention. Referring to FIG. 1, a pre-processing unit 1 is comprised of a model dividing unit 11, a data creating unit 12, a sorting unit 13, and a data storage unit 14. The model dividing unit 11, the data creating unit 12, the sorting unit 13, and the data storage unit 14 consist of, for example, an integrated circuit in which a CPU is mounted, or a one chip microcomputer. The pre-processing unit 1 carries out a process of dividing a polygon model expressing a three-dimensional object into polygon models, creating new vertices from existing vertices of one or more polygons which construct each of the polygon models, into which the original polygon model is divided, for each of the polygon models, and creating vertex data in which a logical connection relation between the vertices of one or more polygon models including the new vertices are expressed by a tree structure. The pre-processing unit 1 also carries out a process of dividing the vertex data into a plurality of divided data, and records the plurality of divided data in an HDD 2.

The HDD 2 is a large-volume secondary storage unit for recording the plurality of divided data of the vertex data which are created by the pre-processing unit 1. Although the example in which the HDD 2 is used as the large-volume secondary storage unit is shown in FIG. 1, the secondary storage unit is not limited to the HDD 2. For example, an arbitrary storage medium having a large storage capacity, such as a flash memory, can be used as the large-volume secondary storage unit.

A polygon model is a shape shown by a set of surfaces each enclosed by three line segments each of which connects between two of three points existing at different positions in a virtual space, and each surface enclosed by the three line segments is called a “polygon”. Further, three points which construct a polygon are referred to as “the vertices of the polygon”, and three line segments each of which connects two vertices of the polygon are referred to as “the sides of the polygon”. Although there are various data structures each expressing a polygon model, it is assumed in this Embodiment 1 that data having both a set of vertex data each of which consists of a unique vertex index and a three-dimensional position, and a set of surface data each of which consists of a unique surface index and three pieces of reference information about reference to the three vertices of a polygon are handled.

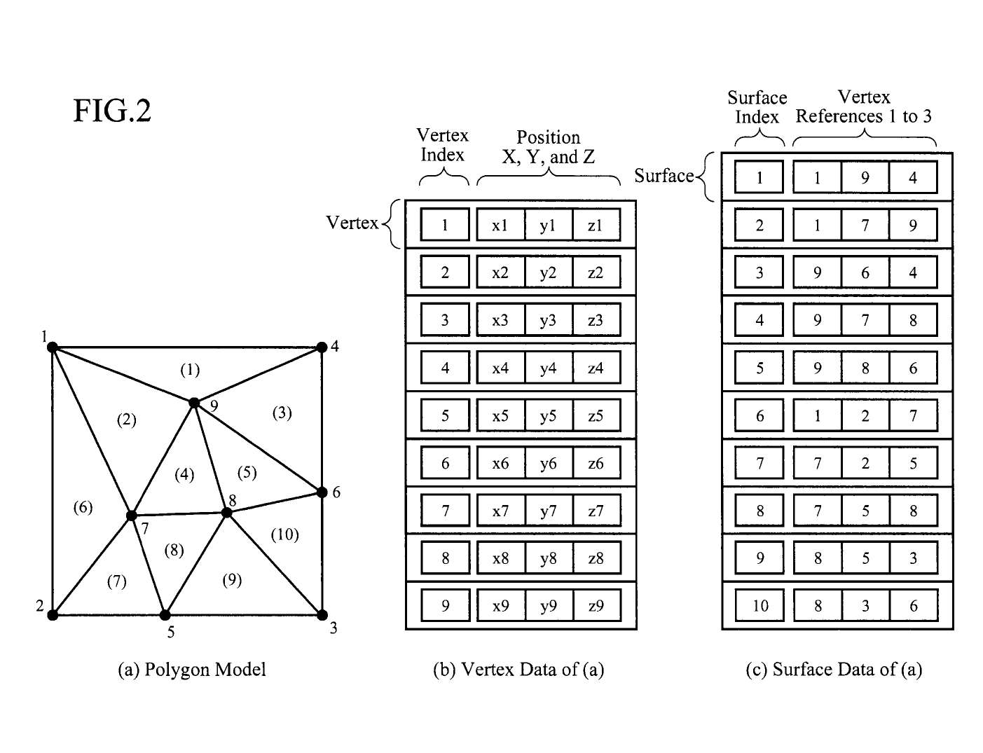

FIG. 2 is an explanatory drawing showing an example of a polygon model, vertex data, and surface data. (a) shows a polygon model which is projected two-dimensionally, and the nine vertices of polygons are shown in this figure with vertex indices ranging from “1” to “9” being respectively attached to the vertices. Further, the polygons each enclosed by line segments each of which connects between two corresponding vertices are shown in the figure with surface indices ranging from “1” to “10” being respectively attached to the polygons (in order to discriminate between the surface indices and the vertex indices, each surface index is parenthesized). (b) shows vertex data which construct the polygon model shown in (a), and each row represents one vertex and holds a unique vertex index and a three-dimensional position (X, Y, Z) in a rectangular coordinate system defined by xyz axes.

Further, (c) shows surface data showing the surfaces of the polygons, and each row represents one polygon surface and holds a unique surface index and three vertex indices as the reference information about reference to the three vertices which construct the corresponding triangular polygon. Although it is assumed that the polygon model is constructed of triangles in this Embodiment 1, the pre-processing unit 1 can have a unit for converting data showing an arbitrary three-dimensional shape into a polygon model to input an arbitrary three-dimensional object and convert the data about this three-dimensional object into a polygon model. Further, the polygon model can be placed in a virtual space having a number of dimensions other than three dimensions.

The run time processing unit 3 is comprised of a data expanding unit 31, a degree of detail determining unit 32, a polygon model constructing unit 33, and a drawing processing unit 34. The degree of detail determining unit 32, the polygon model constructing unit 33, and the drawing processing unit 34 consist of, for example, an integrated circuit in which a CPU is mounted, a one chip microcomputer, or a GPU (Graphics Processing Unit). The run time processing unit 3 carries out a process of reading the plurality of divided data recorded in the HDD 2, and expands the divided data in a memory 4 which is a recording medium from and in which the run time processing unit can read and write data at a higher speed than the run time processing unit reads and writes data from and in the HDD 2. The run time processing unit 3 also carries out a process of determining the degree of detail of drawing of the polygon model in question in consideration of a point of view in the virtual space for each of the polygon models into which the original polygon model is divided by the pre-processing unit 1. The run time processing unit 3 further carries out a process of constructing a polygon model having a number of vertices whose number corresponds to the degree of detail of drawing by making reference to the divided data expanded in the memory 4, and displays an image of the polygon model on an image display unit 5.

Although the memory 4 is a recording medium which has a storage capacity smaller than the HDD 2, but enables data to be read and written therefrom and therein at a higher speed than data are read and written from and in the HDD 2. For example, the memory can be a RAM. The image display unit 5 is an output unit, such as a display, for displaying a polygon model through a drawing process performed by the run time processing unit 3.

The model dividing unit 11 of the pre-processing unit 1 includes an interface for inputting a polygon model expressing a three-dimensional object (e.g. network equipment, such as a LAN card, which is used when inputting a polygon model from a network such as a LAN), and carries out a process of dividing the polygon model into blocks (a set of one or more polygons each existing at a short distance from any other adjacent polygon). The model dividing unit 11 constructs a model dividing unit.

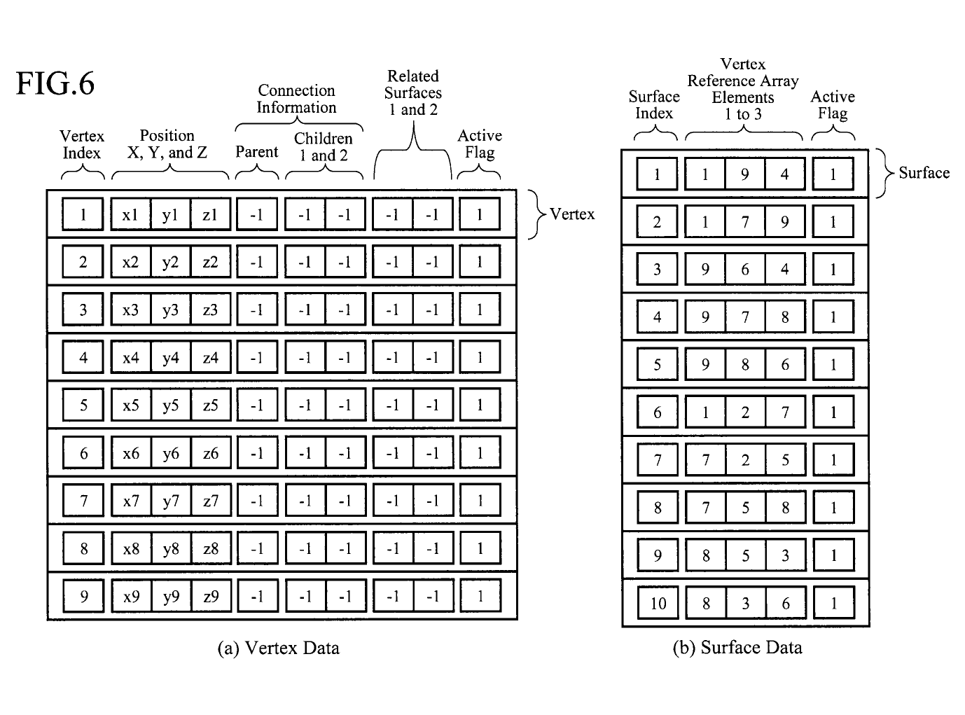

The data creating unit 12 of the pre-processing unit 1 carries out a process of creating new vertices from existing vertices of one or more polygons which construct each of the polygon models, into which the original polygon model is divided by the model dividing unit 11, for each of the polygon models, and creating vertex data in which a logical connection relation between the vertices of one or more polygon models including the new vertices are expressed by a tree structure, and also creating surface data about each surface of the one or more polygons. Although will be mentioned in detail, as shown in FIG. 6, the vertex data consist of, for each vertex of the one or more polygon models including the new vertices, a vertex index for identifying the vertex in question, position information showing the three dimensional position of the vertex, connection information showing vertices each having a logical connection relation with the vertex, an active flag showing whether or not the vertex is a target to be drawn, and so on. Further, the surface data consist of, for each surface of the one or more polygon models including the new vertices, a surface index for identifying the surface in question, vertex information showing the vertices which construct the surface, an active flag showing whether or not the surface is a target to be drawn, and so on.

The sorting unit 13 of the pre-processing unit 1 carries out a process of updating the vertex indices of the vertex data and the vertex indices of the surface data which are created by the data creating unit 12, and a process of dividing the vertex data into plural divided data and outputting the plural divided data into which the vertex data are divided. The data storage unit 14 of the pre-processing unit 1 carries out a process of storing the divided data of the vertex data outputted from the sorting unit 13 in the HDD 2. A data storage unit is comprised of the sorting unit 13 and the data storage unit 14.

The data expanding unit 31 of the run time processing unit 3 carries out a process of reading the divided data specified by a read command outputted from the polygon model constructing unit 33 from among the plurality of divided data stored in the HDD 2 and expanding the divided data in the memory 4 while discarding the divided data specified by a discard command outputted from the polygon model constructing unit 33 from among the divided data expanded in the memory 4. The data expanding unit 31 constructs a data expanding unit.

The degree of detail determining unit 32 of the run time processing unit 3 includes an interface for inputting visual point information showing a point of view in the virtual space (e.g. network equipment, such as a LAN card, which is used when inputting a polygon model from a network such as a LAN), and carries out a process of, for each of the polygon models into which the original polygon model is divided by the model dividing unit 11 of the pre-processing unit 1, determining the degree of detail of drawing of the polygon model in question in consideration of the point of view in the virtual space shown by the visual point information. More specifically, the degree of detail determining unit 32 carries out a process of using, as a determination criterion, whether or not each of the polygon models divided is located at a position where the polygon model can be seen from the point of view in the virtual space, the distance from the point of view in the virtual space to each of the polygon models divided, or whether each of the polygon models divided constructs a part of the outline of the original polygon model before dividing (i.e. the polygon model provided to the pre-processing unit 1) when the divided polygon model in question is viewed from the point of view in the virtual space to calculate the contribution of an image of each of the polygon models divided to an image of the original polygon model before dividing, and determining the degree of detail of drawing of the polygon model in such a way that the higher degree of contribution to the image of the original polygon model before dividing the image of the polygon model in question has, the higher degree of detail of drawing the polygon model in question has. The degree of detail determining unit 32 constructs a degree of detail determining unit.

The polygon model constructing unit 33 of the run time processing unit 3 carries out a process of, for each of the polygon models acquired by the model dividing unit 11 of the pre-processing unit 1, updating the active flags of the vertex data and the surface data included in the divided data expanded in the memory 4 in such a way that the number of the vertices in the polygon model becomes equal to the number of vertices corresponding to the degree of detail determined by the degree of detail determining unit 32 to construct a polygon model which is a target to be drawn. The polygon model constructing unit 33 also carries out a process of outputting a read command for specifying the divided data to be read and a discard command for specifying the divided data to be discarded to the data expanding unit 31. More specifically, the polygon model constructing unit carries out a process of, when it is impossible to construct a polygon model having a number of vertices whose number corresponds to the degree of detail determined by the degree of detail determining unit 32 only by using the divided data currently being expanded in the memory 4, outputting a read command for commanding reading of other divided data to the data expanding unit 31, and, when divided data excessive for construction of a polygon model having a number of vertices whose number corresponds to the degree of detail determined by the degree of detail determining unit 32 are expanded in the memory 4, outputting a discard command for commanding discarding of the excessive divided data to the data expanding unit 31. The polygon model constructing unit 33 constructs a polygon model constructing unit.

The drawing processing unit 34 of the run time processing unit 3 carries out a process of drawing an image of the polygon model constructed by the polygon model constructing unit 33 (i.e. a polygon model which consists of the vertices in each of which the active flag updated by the polygon model constructing unit 33 shows that the vertex is a target to be drawn) on, for example, an internal video RAM, and outputting the image to the image display unit 5. The drawing processing unit 34 constructs a drawing unit.

In FIG. 1, it is assumed that the pre-processing unit 1, the HDD 2, the run time processing unit 3, the memory 4, and the image display unit 5, which are components of the image display device, are comprised of pieces of hardware for exclusive use, respectively. In a case in which the pre-processing unit 1 and the run time processing unit 3 which are components of the image display device are comprised of a computer, a program in which the processes carried out by the pre-processing unit 1 and the run time processing unit 3 are described can be stored in a memory of the computer and a CPU of the computer can be made to execute the program stored in the memory.

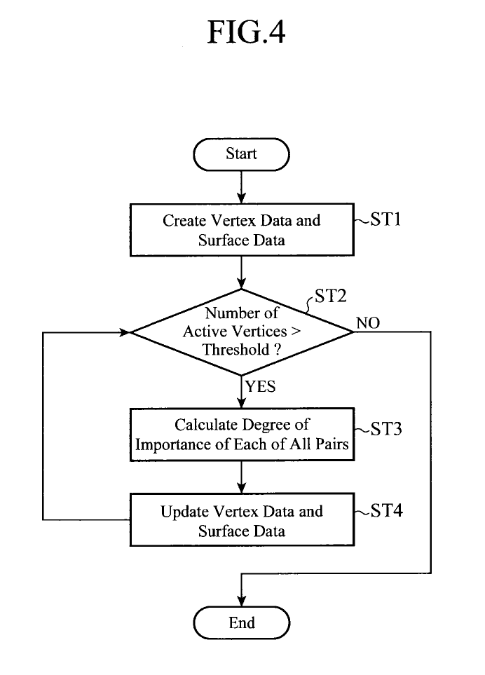

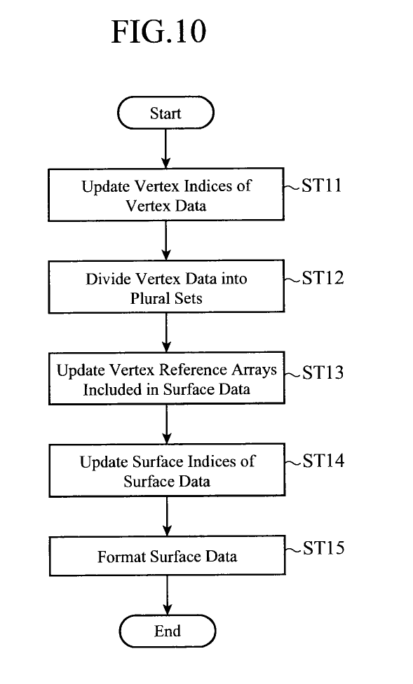

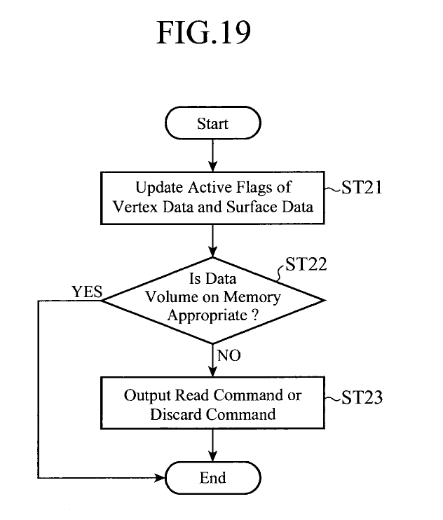

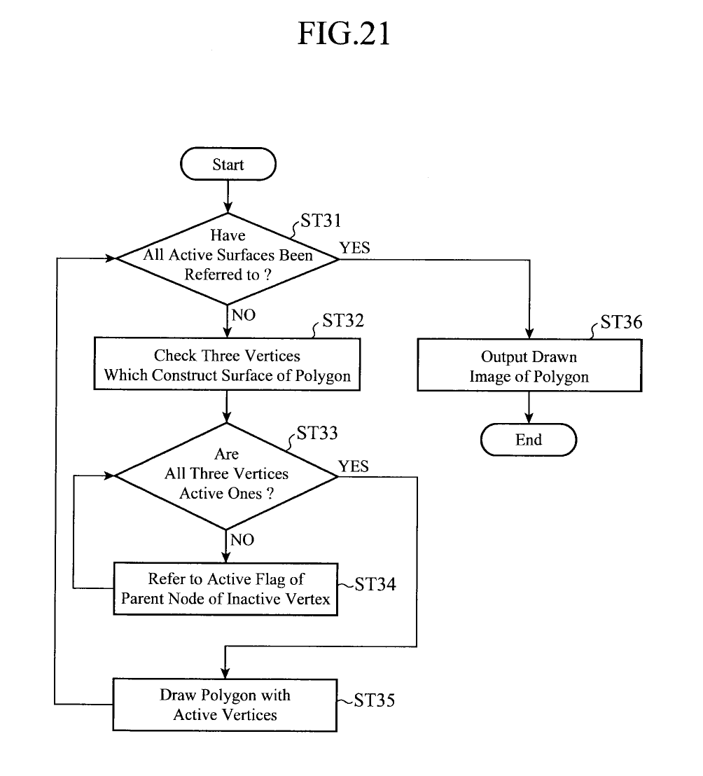

FIG. 4 is a flow chart showing the processing carried out by the data creating unit 12 in the pre-processing unit 1. FIG. 10 is a flow chart showing the processing carried out by the sorting unit 13 in the pre-processing unit 1. FIG. 19 is a flow chart showing the processing carried out by the polygon model constructing unit 33 in the run time processing unit 3. FIG. 21 is a flow chart showing the processing carried out by the drawing processing unit 34 in the run time processing unit 3.

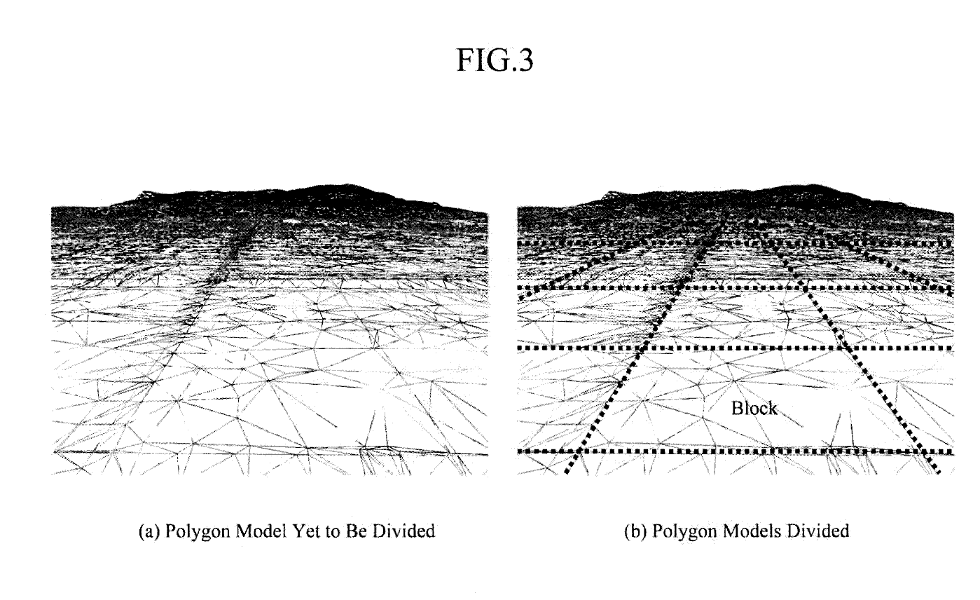

Next, the operation of the image display device will be explained. When receiving a polygon model expressing a three-dimensional object, the model dividing unit 11 of the pre-processing unit 1 divides the polygon model into blocks (a set of one or more polygons each existing at a short distance from any other adjacent polygon). FIG. 3 is an explanatory drawing showing an example of the division of the polygon model by the model dividing unit 11. FIG. 3(a) shows the polygon model yet to be divided, and FIG. 3(b) shows the polygon models divided. In FIG. 3(b), each dashed line shows a boundary between blocks.

In the example of FIG. 3, the surface of the polygon model is divided into blocks in the shape of a simple grid. As an alternative, the surface of the polygon model can be divided into blocks according to an arbitrary dividing method, e.g. a method of dividing the surface of the polygon model in such a way that the number of vertices of a polygon included in each block is equal. Further, when the division of the provided polygon model may cause a change in the shape of each polygon, such as a parting in the polygon surface, a process of processing the vertices and the surface of each polygon (a process of preventing a change of the shape of each polygon) or the like can be carried out in advance in such a way that the sides of each polygon match a divided surface.

After the model dividing unit 11 divides the polygon model into blocks, the data creating unit 12 of the pre-processing unit 1 creates new vertices from the existing vertices of one or more polygons which construct each of the polygon models, into which the original polygon model is divided by the model dividing unit, for each of the polygon models which is a block unit, and creates vertex data in which a logical connection relation between the vertices of one or more polygon models including the new vertices are expressed by a tree structure. Hereafter, the processing carried out by the data creating unit 12 will be explained concretely.

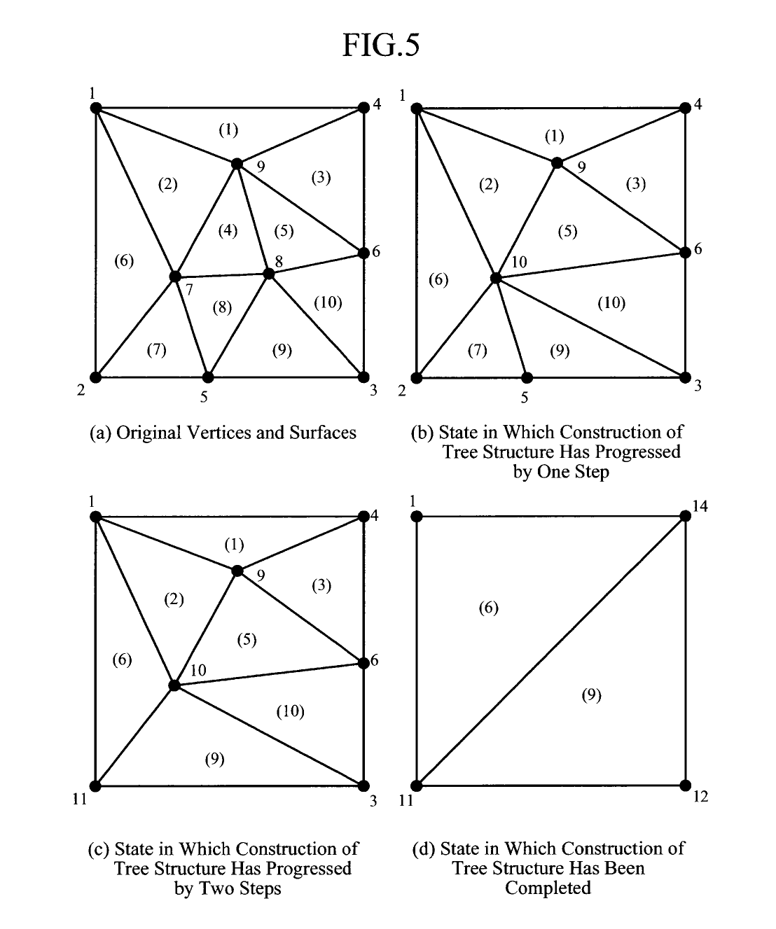

First, the data creating unit 12 creates vertex data and surface data in an initial state. More specifically, for each of the polygon models which is a block unit, the data creating unit 12 creates vertex data having a tree structure in which the existing vertices of the one or more polygons which construct the polygon model in question are defined as “leaves”, and also creates surface data about each surface of the one or more polygons (step ST1 of FIG. 4). FIG. 5 is an explanatory drawing showing a state in which each polygon model which is a block unit varies as the processing carried out the data creating unit 12 progresses. In FIG. 5, 1 to 14 denote vertex indices which will be mentioned later, and (1) to (10) denote surface indices which will be mentioned later. FIG. 6 is an explanatory drawing showing vertex data and surface data which are created from the polygon model shown in FIG. 5(a).

FIG. 6(a) shows vertex data having a tree structure which the data creating unit 12 creates from the polygon model shown in FIG. 5(a) which is one block when the polygon model is provided thereto. Each row in the vertex data shows one vertex, and is comprised of the following pieces of information (1) to (5).

(1) A vertex index for identifying the vertex (e.g. a number ranging from 1 to 9)

(2) Position information showing the three dimensional position (X, Y, Z) of the vertex

(3) Connection information showing vertices each having a logical connection relation with the vertex (a vertex index showing a vertex corresponding to the parent node of the vertex, and vertex indices each showing a vertex corresponding to a child node of the vertex)

However, because no new vertex is created from the existing vertices in this stage (the creating process of creating new vertices will be mentioned later), neither a vertex corresponding to the parent node nor vertices corresponding to child nodes exist, and “−1” showing that neither a vertex corresponding to the parent node nor vertices corresponding to child nodes exist is substituted into each piece of connection information shown in FIG. 6(a).

(4) Surface indices each for specifying a related surface which is a polygon surface which is reduced in a process of creating a tree structure which will be mentioned later

However, because no polygon surface which is reduced exists in this stage, “−1” is substituted into each of the surface indices for specifying a related surface.

(5) An active flag showing whether or not the vertex is a target to be drawn (although the active flag shows that the vertex is to be drawn by the run time processing unit 3 when the active flag is “1” (active), whereas the active flag shows that that the vertex is not to be drawn by the run time processing unit 3 when the active flag is “0” (inactive), all the active flags are initialized to “1” (active) in this stage.)

FIG. 6(a) shows surface data which the data creating unit 12 creates from the polygon model shown in FIG. 5(a) which is one block when the polygon model is provided thereto. For the surface data, a number of rows whose number is the same as the number of surfaces of polygons which are included in the inputted block, and each row shows one surface. Each row of the vertex data is comprised of the following pieces of information (1) to (3).

(1) A surface index for identifying a corresponding surface (e.g. a number ranging from 1 to 10)

(2) Vertex indices showing the three vertices which construct the surface (a vertex reference array)

(3) An active flag showing whether or not the corresponding surface is a target to be drawn (although when the active flag is “1” (active), this flag shows that the surface is to be drawn by the run time processing unit 3, whereas when the active flag is “0” (inactive), this flag shows that the surface is not to be drawn by the run time processing unit 3, all the active flags are initialized to “1” (active) in this stage because no polygon surface which is reduced exists.)

Hereinafter, a vertex whose active flag is “1” and a surface whose active flag is “1” will be referred to as an active vertex and an active surface while a vertex whose active flag is “0” and a surface whose active flag is “0” will be referred to as an inactive vertex and an inactive surface.

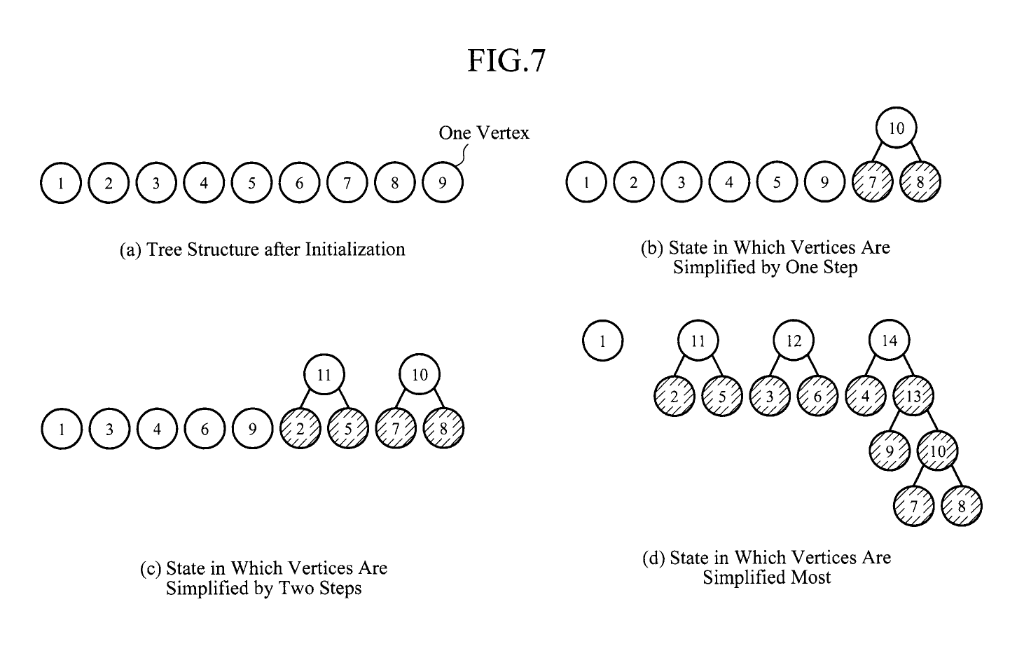

FIG. 7 is an explanatory drawing showing a logical connection relation between vertices which varies as the process done by the data creating unit 12 progresses. FIG. 7(a) particularly shows a logical connection relation between the vertices shown by the vertex data shown in FIG. 6(a). Because no vertex corresponds to the parent node and no vertex corresponding to a child exist for each vertex in the vertex data shown in FIG. 6(a) (each index whose vertex index ranges from “1” to “9”), as mentioned above, each of the vertices shown by the vertex data is not connected to any other vertex. In FIG. 7, each active vertex is expressed by a circle which is filled with white, and each inactive vertex is expressed by a circle which is filled with hatch lines.

After creating the vertex data and the surface data in an initial state, the data creating unit 12 compares the number of active vertices in the vertex data with a preset threshold. Although the threshold is a preset arbitrary numerical value, when the polygon model provided to the pre-processing unit 1 is divided into square blocks, as shown in FIG. 3, “4” which is the number of vertices of each of the blocks is preset as the threshold. Further, when the polygon model provided to the pre-processing unit 1 is divided into pentagonal blocks, “5” which is the number of vertices of each of the blocks is preset as the threshold. The threshold can be set up arbitrarily and is not limited to “4” even when each block is a rectangle. For example, the threshold can be a numerical value such as “5” or “6” (but is a numerical value smaller than the number of vertices of the one or more polygons included in each block).

When the number of active vertices is larger than the preset threshold, the data creating unit 12 shifts to a process of step ST3 which will be mentioned below, whereas when the number of active vertices is equal to or smaller than the threshold, the data creating unit 12 ends the process (step ST2). Because all the vertices (the vertices whose vertex indices range from “1” to “9”) are active ones in this stage, the data creating unit shifts to the next process of step ST3 because the number of active vertices is larger than the threshold.

When the number of active vertices is larger than the threshold, the data creating unit 12 extracts two arbitrary vertices (referred to as a “pair” from here on) in order from among all the active vertices included in the vertex data, and calculates the degree of importance of the pair for the block as an evaluated value (step ST3). The data creating unit calculates the degree of importance of each of all the pairs in the active vertices. For example, when there are nine active vertices, the data creating unit calculates the degree of importance of each of ₉C₂=36 pairs. As a yardstick for measuring the degree of importance of two vertices which pair up with each other, for example, the geometric distance between the two vertices which pair up with each other, or the amount of deformation of the polygon model which occurs when one of the two vertices which pair up with each other is deleted can be used. When calculating the degree of importance of the pair, an appropriate yardstick can be selected in consideration of the time required to calculate the degree of importance and the accuracy of the degree of importance.

After calculating the degree of importance of each of all the pairs as an evaluated value, the data creating unit 12 identifies the pair having the lowest evaluated value, sets the active flag of each of the two vertices which construct the pair to “0”, and changes the two vertices to inactive ones. For example, when the pair of the vertices 7 and 8 shown in FIG. 5(a) has the lowest evaluated value, the data creating unit sets the active flags of the vertices 7 and 8 to “0” and changes the vertices 7 and 8 to inactive ones (refer to FIG. 7(b)).

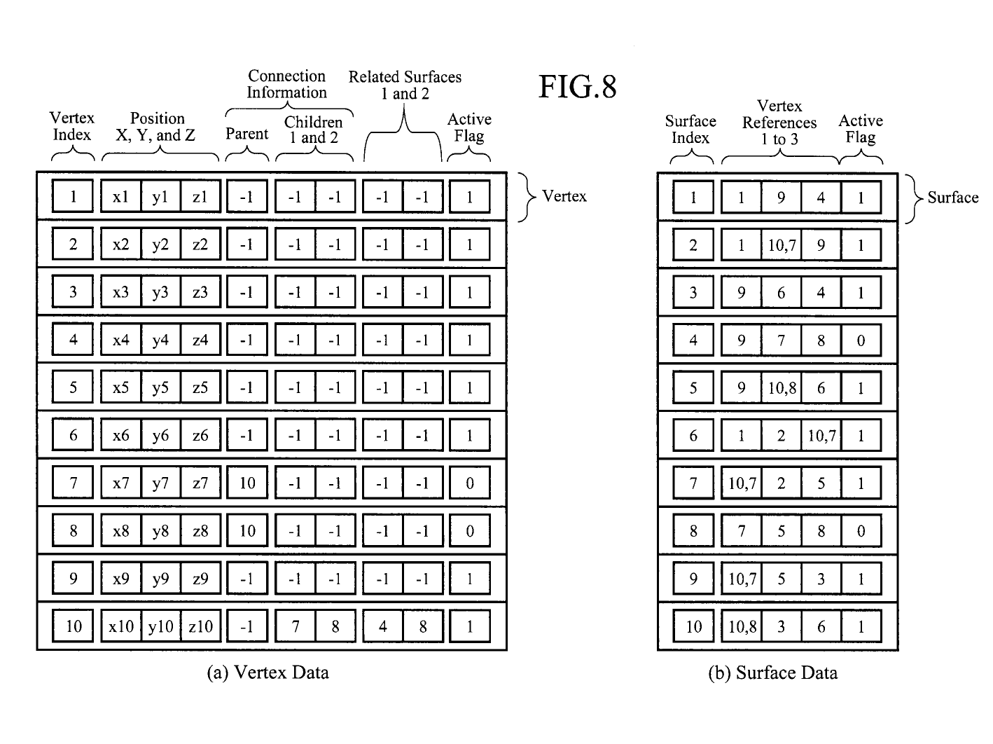

Further, the data creating unit 12 newly creates one active vertex at the same position as one of the two vertices which construct the pair, and adds a vertex index of “10” which the data creating unit acquires by adding “1” to the maximum vertex index of the vertex data (in the example of FIG. 6(a), “9”), as a new vertex index, to the vertex data (refer to FIG. 8(a)). FIG. 8 is an explanatory drawing showing the vertex data and the surface data on which the data creating unit 12 has carried out an update process of updating the vertex data and the surface data once.

Although in FIG. 5(b) an example in which the data creating unit creates an active vertex 10 at the same position as the vertex 7 is shown, the data creating unit can alternatively create an active vertex 10 at the same position as the vertex 8. Whether to select either the position of the vertex 7 and that of the vertex 8 is not particularly limited. For example, the data creating unit can calculate both the density of the polygon model in the case of creating the active vertex 10 at the same position as the vertex 7 and the density of the polygon model in the case of creating the active vertex 10 at the same position as the vertex 8, and select the position which provides the higher density of the polygon model. As an alternative, the data creating unit can calculate both the amount of deformation of the polygon model in the case of creating the active vertex 10 at the same position as the vertex 7 and the amount of deformation of the polygon model in the case of creating the active vertex 10 at the same position as the vertex 8, and select the position which provides the smaller amount of deformation of the polygon model.

Although in this embodiment the example in which the data creating unit 12 newly creates one active vertex at the same position as one of the two vertices which construct the pair is shown, the present embodiment is not limited to this example. For example, the data creating unit can newly create one active vertex at either a position showing the average of the two vertices or a position where the amount of deformation of the polygon model is the smallest.

After changing, for example, the vertices 7 and 8 to inactive ones, the data creating unit 12 searches for the surface of the polygon which has both the vertex 7 and the vertex 8 as its vertices by making reference to the surface data, sets the active flag of the surface to “0” and changes the surface into an inactive surface. In the example of FIG. 5(a), the data creating unit changes the surfaces (4) and (8) of the polygon to inactive surface (refer to FIG. 8(b)).

After updating the active flags and adding a new vertex index, the data creating unit 12 carries out an update process of updating the vertex data and the surface data (step ST4). More specifically, in the vertex data, the three dimensional position (x10, y10, z10) of the vertex 10 is recorded in the column of the position information on the vertex 10 to which the vertex index of “10” is added, the vertex indices of the vertices 7 and 8 are recorded in the column of the child nodes of the vertex 10, and the surface indices of the surfaces (4) and (8) which are changed to inactive are recorded in the column of the related surfaces of the vertex 10, as shown in FIG. 8(a). Further, the vertex index of the vertex 10 is recorded in the column of the parent node of each of the vertices 7 and 8 which are changed to inactive. “1” is recorded as the active flag of the vertex 10, and “0” is recorded as each of the active flags of the vertices 7 and 8.

In the surface data, the vertex index of the vertex 10 is recorded in the column showing the vertices which construct the surface (10) to which the surface index of “10” is added in such a way as to be placed before the vertex index of the vertex 8 which has been recorded from the first and which is changed to inactive, as shown in FIG. 8(b). Further, the vertex index of the vertex 10 is recorded in the column which showing the vertices which construct each of the surfaces (2), (5), (6), (7), and (9) which includes the vertex 7 or 8 as its vertices in such a way as to be placed before the vertex index of the vertex 7 or 8.

FIG. 7(b) shows a logical connection relation between the vertices on which the data creating unit 12 has carried out the processes of steps ST3 and ST4 once. FIG. 7(b) shows a state in which the vertex 10 is newly created and is connected as the parent nodes of the vertices 7 and 8 which have been updated from active vertices to inactive vertices.

After carrying out the update process of updating the vertex data and the surface data, the data creating unit 12 returns to the process of step ST2, and repeatedly carries out the processes of steps ST2 to ST4 until the number of active vertices becomes equal to or smaller than the threshold. Although a detailed explanation of a process will be omitted hereafter, FIG. 5(c) shows the polygon model on which the data creating unit 12 has carried out the processes of steps ST3 and ST4 twice. In this example, a vertex 11 is newly created from the vertices 2 and 5. FIG. 7(c) shows a logical connection relation between the vertices on which the data creating unit 12 has carried out the processes of steps ST3 and ST4 twice. FIG. 7(c) shows a state in which the vertex 11 is newly created and is connected as the parent nodes of the vertices 2 and 5 which have been updated from active vertices to inactive vertices.

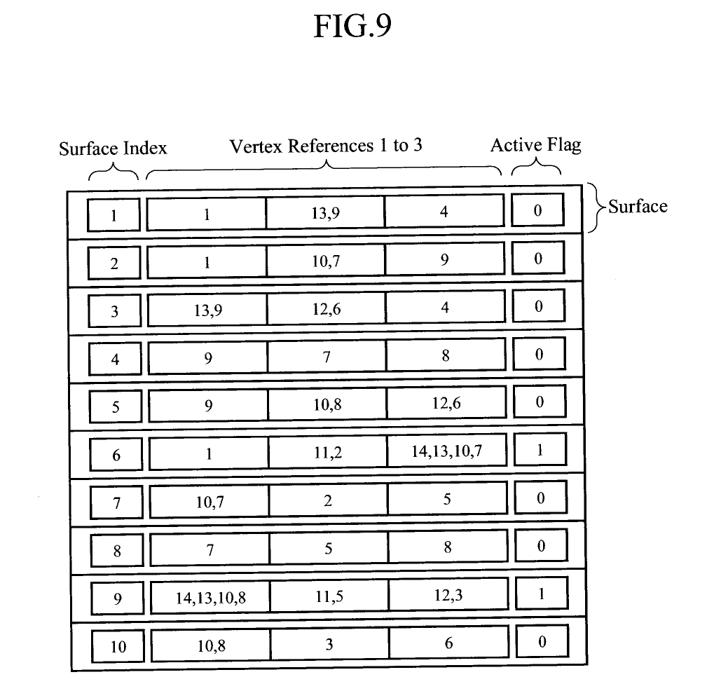

FIG. 5(d) shows the polygon model on which the data creating unit 12 has carried out the processes of steps ST3 and ST4 five times (i.e. the polygon model at the time that the number of active vertices is equal to the threshold). FIG. 7(d) shows a logical connection relation between the vertices on which the data creating unit 12 have carried out the processes of steps ST3 and ST4 five times. FIG. 9 is an explanatory drawing showing the surface data which are acquired after the processing done by the data creating unit 12 is completed, and corresponds to FIGS. 5(d) and 7(d).

After the data creating unit 12 creates the vertex data, the sorting unit 13 of the pre-processing unit 1 carries out a process of updating the vertex indices of the vertex data and the vertex indices of the surface data, and also carries out a process of dividing the vertex data into divided data and outputting the divided data of the vertex data to the data storage unit 14. Hereafter, the processing carried out by the sorting unit 13 will be explained concretely.

The sorting unit 13 updates the vertex indices of the vertex data created by the data creating unit 12 according to three rules shown below (step ST11 of FIG. 10).

### [Rule 1]

A unique integer is added, as a vertex index, to the vertex which is the root.

### [Rule 2]

A vertex index which is larger than a maximum of the vertex index of the root and the vertex index of the parent node is added to a vertex other than the vertex which is the root. Further, contiguous integers are added, as vertex indices, to a plurality of vertices which are child nodes connected to the same parent node, respectively.

### [Rule 3]

A degree of contribution of each vertex to the shape of the polygon model (e.g. the evaluated value calculated by the data creating unit 12) is calculated, and a smaller vertex index is added to a vertex having a higher degree of contribution.

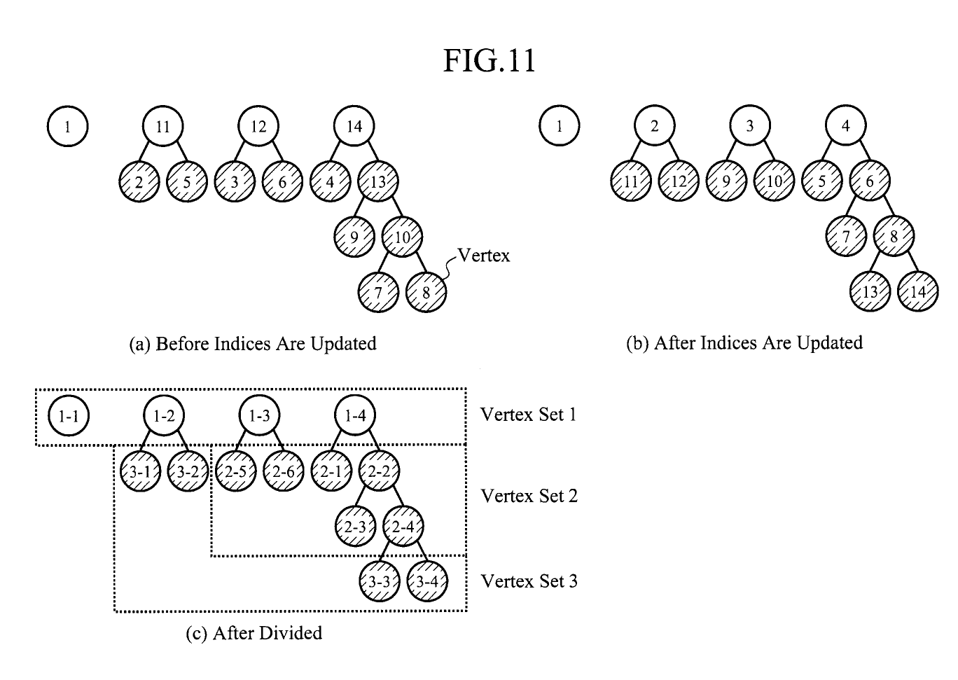

FIG. 11(a) shows a logical connection relation between the vertices whose vertex indices have not been updated yet by the sorting unit 13, and FIG. 11(b) shows a logical connection relation between the vertices whose vertex indices have been updated by the sorting unit 13. The logical connection relation between the vertices shown in FIG. 11(a) is the same as that shown in FIG. 7(d) (i.e. the logical connection relation between the vertices which have been processed by the data creating unit 12), and the number of active vertices (vertices each of which is a root) is four when the processing carried out by the data creating unit 12 is completed. The rules 1 and 3 are applied to the four active vertices, so that the vertex indices of the four active vertices are updated from “1”, “11”, “12”, and “14” to “1”, “2”, “3”, and “4”, respectively, as shown in FIG. 11(b).

The rule 2 is applied to the ten inactive vertices, so that their vertex indices are updated to larger vertex indices than those of the four active vertices. Further, the vertex index of a child node (an inactive vertex) connected to an inactive vertex has been updated to a larger vertex index than that of the inactive vertex which is the parent node of the child node. In addition, the vertex indices of a plurality of child nodes (inactive vertices) connected to an identical parent node are updated in such a way as to have contiguous integer values. The rule 3 is applied also to the ten inactive vertices. As a result, for example, the vertex indices of the six inactive vertices connected to the three active vertices are updated from “2”, “5”, “3”, “6”, “4”, and “13” to “11”, “12”, “9”, “10”, “5”, and “6”, respectively. Further, the vertex indices of the four inactive vertices connected to the inactive vertex are updated from “9”, “10”, “7”, and“8” to “7”, “8”, “13”, and “14”, respectively.

After updating the vertex indices of the vertex data, the sorting unit 13 divides the vertex data into a plurality of sets by using preset thresholds (step ST12). For example, two thresholds are set up when the sorting unit divides the vertex data into three sets, and four thresholds are set up when the sorting unit divides the vertex data into five sets. In this Embodiment 1, for the sake of simplicity, it is assumed that the sorting unit divides the vertex data into three sets, and two thresholds are set up. In this case, two arbitrary numerical values are set up as the two thresholds. For example, when the vertices 1 to 4 are classified as a set 1, the vertices 5 to 10 are classified as a set 2, and the vertices 11 to 14 are classified as a set 3, “4” and “10” are set up as the thresholds. The two thresholds can be changed dynamically according to the number of vertices of the polygon model.

For example, when two thresholds are set up and are “4” and “10”, the sorting unit 13 classifies the vertex data about the vertices whose vertex indices are equal to or smaller than “4” (the vertices to which the vertex indices of “1”, “2”, “3”, and “4” are respectively added) as a set 1 (a set having a set index of “1”). The sorting unit 13 also classifies the vertex data about the vertices whose vertex indices are larger than “4” and equal to or smaller than “10” (the vertices to which the vertex indices of “5”, “6”, “7”, “8”, “9”, and “10” are respectively added) as a set 2 (a set having a set index of “2”). The sorting unit 13 further classifies the vertex data about the vertices whose vertex indices are larger than “10” (the vertices to which the vertex indices of “11”, “12”, “13”, and “14” are respectively added) as a set 3 (a set having a set index of “3”). In this case, the sorting unit 13 classifies the vertices which are roots of the tree structure in such a way that they belong to the same set (e.g. the set having a set index of “1”). To this end, in the example shown in FIG. 11, one of the thresholds is set to “4”.

After classifying the vertex data into the plurality of sets, the sorting unit 13 updates the vertex index of each vertex to an index (a set index—an in-set vertex index) which consists of a combination of a set index and a vertex index unique in the set to which the vertex belongs. For example, the vertex indices of the vertices belonging to the set 1 are updated from “1”, “2”, “3”, and “4” to “1-1”, “1-2”, “1-3”, and “1-4”, respectively. Further, the vertex indices of the vertices belonging to the set 2 are updated from “5”, “6”, “7”, “8”, “9”, and “10” to “2-1”, “2-2”, “2-3”, “2-4”, “2-5”, and “2-6”, respectively. In addition, the vertex indices of the vertices belonging to the set 3 are updated from “11”, “12”, “13”, and “14” to “3-1”, “3-2”, “3-3”, and “3-4”, respectively.

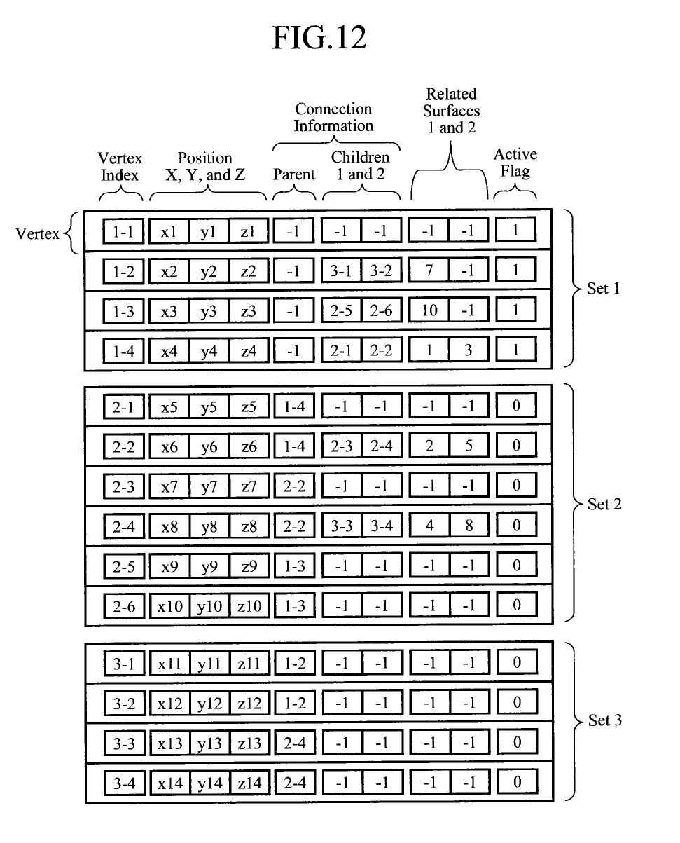

FIG. 12 is an explanatory drawing showing an example of the data structure expressing the vertices having a tree structure shown in FIG. 11(c). Each data shown in FIG. 12 is comprised of a vertex index for identifying a vertex, position information showing the three dimensional position of the vertex, an vertex index showing the parent node of the vertex, vertex indices each showing a child node, surface indices each showing a related surface, and an active flag.

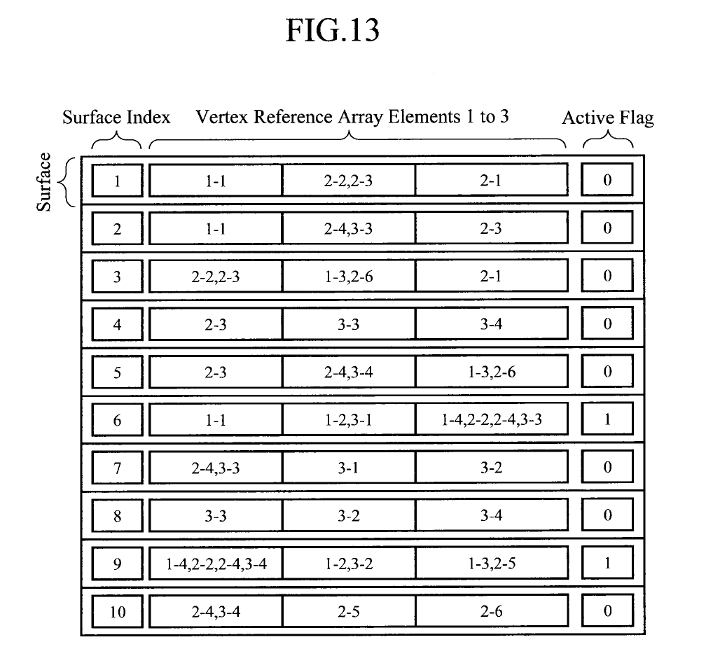

After updating the vertex indices, the sorting unit 13 updates the vertex indices (the vertex reference arrays) included in the surface data according to the vertex indices updated thereby (step ST13). FIG. 13 is an explanatory drawing showing the surface data in which the vertex indices (the vertex reference arrays) are updated. As shown in FIGS. 9 and 13, the vertex index of “1” recorded in the vertex reference array corresponding to the surface index of “1” is replaced by “1-1”, the vertex index of “13” recorded in the vertex reference array is replaced by “2-2”, the vertex index of “9” recorded in the vertex reference array is replaced by “2-3”, and the vertex index of “4” recorded in the vertex reference array is replaced by “2-1”. Each vertex index recorded in the vertex reference array corresponding to each of the surface indices of “2” to “10” is similarly replaced by the corresponding vertex index.

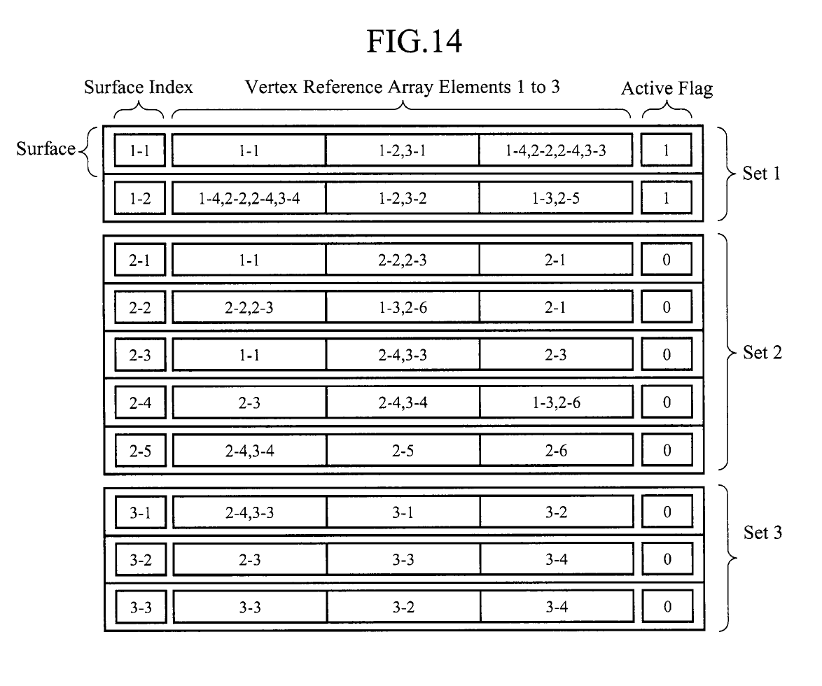

After updating the vertex indices (the vertex reference arrays) included in the surface data, the sorting unit 13 determines the set to which each surface of the polygon model belongs, and updates the surface index for identifying each surface (step ST14). More concretely, the sorting unit determines the set to which each surface of the polygon model belongs as follows. FIG. 14 is an explanatory drawing showing the surface data in which the surface indices are updated.

### [Set 1]

The sorting unit determines that a surface for which one or more vertex indices belonging to the set 1 are recorded in every of the three elements 1, 2, and 3 of its vertex reference array included in the surface data belongs to the set 1. In the example of FIG. 13, because one or more vertex indices belonging to the set 1 are recorded in every of the three elements 1, 2, and 3 of the vertex reference array of each of the surfaces whose surface indices are “6” and “9”, the sorting unit classifies the surfaces as the set 1 (refer to FIG. 14).

### [Set 2]

The sorting unit determines that a surface except the surfaces belonging to the set 1 for which a vertex index belonging to the set 1 or 2 is recorded in every of the three elements 1, 2, and 3 of its vertex reference array belongs to the set 2. In the example of FIG. 13, because a vertex index belonging to the set 1 or 2 is recorded in every of the three elements 1, 2, and 3 of the vertex reference array of each of the surfaces whose surface indices are “1”, “2”, “3”, “5”, and “10”, the sorting unit classifies the surfaces as the set 2 (refer to FIG. 14).

### [Set 3]

The sorting unit determines that any surface except the surfaces belonging to the set 1 or 2 belongs to the set 3. In the example of FIG. 13, because each of the surfaces whose surface indices are “4”, “7” and “8” belongs to neither the set 1 nor the set 2, the sorting unit classifies the surfaces as the set 3 (refer to FIG. 14).

After determining the set to which each surface of the polygon model belongs, the sorting unit 13 updates the surface index of each surface to an index (a set index—an in-set vertex index) which consists of a combination of a set index and a vertex index unique in the set to which the surface belongs, as shown in FIG. 14. For example, the surface indices of the surfaces belonging to the set 1 are updated from “6” and “9” to “1-1” and “1-2”, respectively. Further, the surface indices of the surfaces belonging to the set 2 are updated from “1”, “3”, “2”, “5”, and “10” to “2-1”, “2-2”, “2-3”, “2-4”, and “2-5”, respectively. In addition, the surface indices of the surfaces belonging to the set 3 are updated from “7”, “4”, and “8” to “3-1”, “3-2”, and “3-3”, respectively.

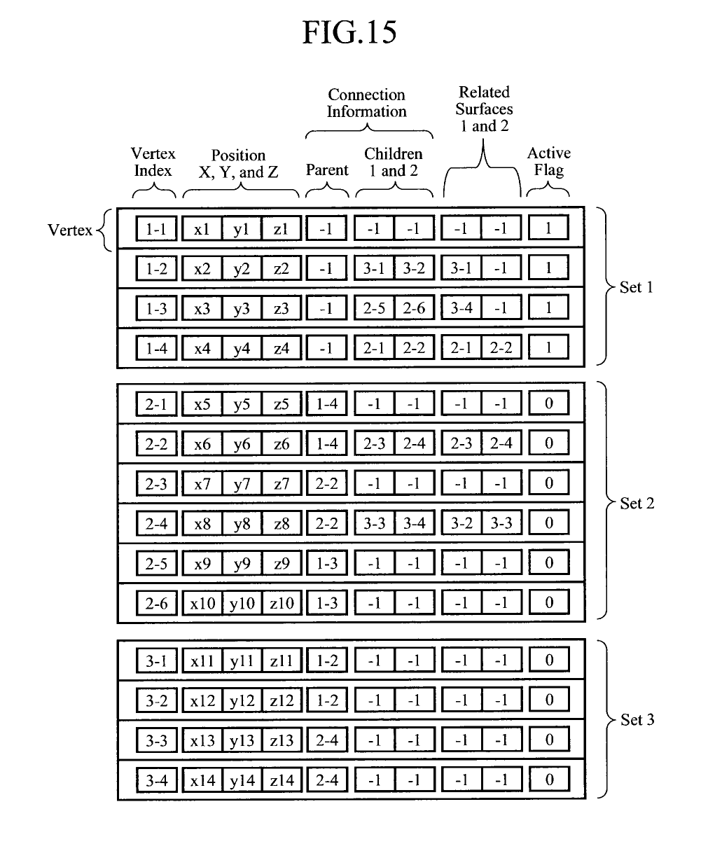

After updating the surface indices, the sorting unit 13 updates the surface indices each showing a related surface included in the vertex data according to the surface indices updated thereby. FIG. 15 is an explanatory drawing showing the vertex data in which the surface indices each showing a related surface are updated. As shown in FIGS. 12 and 5, the surface index of “7” which is recorded in the column of the related surfaces corresponding to the vertex index of “1-2” is replaced by “3-1”, and the surface indices of “1” and “3” which are recorded in the column of the related surfaces corresponding to the vertex index of “1-4” are replaced by “2-1” and “2-2”, respectively. The other surface indices are replaced similarly.

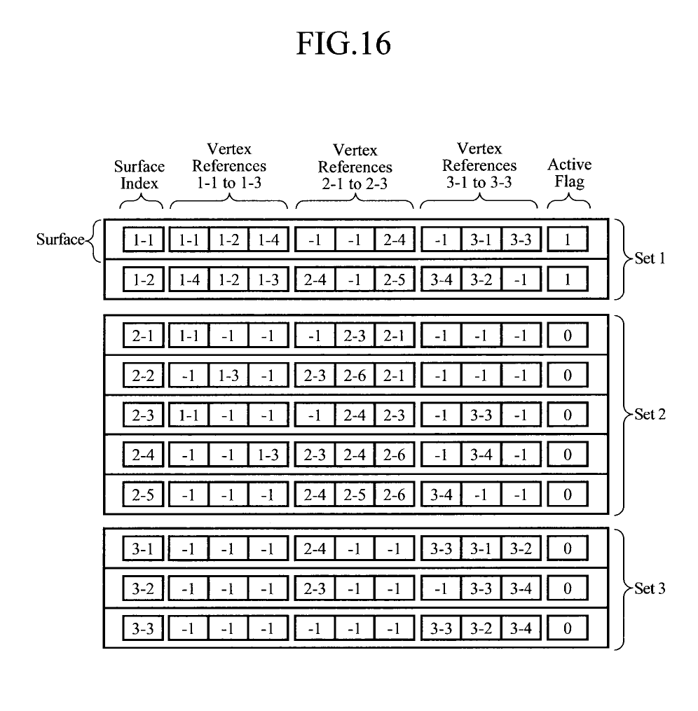

Finally, the sorting unit 13 formats the surface data according to a storage format in which the surface data are to be stored in the HDD 2 (step ST15). More specifically, the sorting unit 13 converts the surface data shown in FIG. 14 into surface data shown in FIG. 16. FIG. 16 is an explanatory drawing showing the surface data into which the surface data shown in FIG. 4 are converted by the sorting unit 13. The storage format of the surface data includes the surface index of each surface, vertex references 1-1 to 1-3, vertex references 2-1 to 2-3, vertex references 3-1 to 3-3, and an active flag.

The surface index and the active flag of each surface are copies of the surface index and the active flag of each surface shown in FIG. 14. When one or more vertex indices belonging to the set 1 are included in the vertex indices recorded in one or more of the elements 1 to 3 of the vertex reference array of a surface shown in FIG. 14, the largest one of the one or more vertex indices is copied to the corresponding one or more of the vertex references 1-1 to 1-3 of the surface. For example, “1-1” recorded in the element 1 of the vertex reference array of FIG. 14 is copied to the vertex reference 1-1 of the surface whose surface index is “1-1”, “1-2” recorded in the element 2 of the vertex reference array of FIG. 14 is copied to the vertex reference 1-2 of the surface whose surface index is “1-1”, and “1-4” recorded in the element 3 of the vertex reference array of FIG. 14 is copied to the vertex reference 1-3 of the surface whose surface index is “1-1”.

When one or more vertex indices belonging to the set 2 are included in the vertex indices recorded in one or more of the elements 1 to 3 of the vertex reference array of a surface shown in FIG. 14, the largest one of the one or more vertex indices is copied to the corresponding one or more of the vertex references 2-1 to 2-3. For example, because there is no vertex index belonging to the set 2 in the element 1 of the vertex reference array of FIG. 14, “−1” is recorded in the vertex reference 2-1 of the surface whose surface index is “1-1”. Because there is no vertex index belonging to the set 2 in the element 2 of the vertex reference array of FIG. 14, “−1” is recorded in the vertex reference 2-2 of the surface whose surface index is “1-1”. “2-4” which is the larger one of “2-2” and “2-4” which are recorded in the element 3 of the vertex reference array of FIG. 14 is copied to the vertex reference 1-3 of the surface whose surface index is “1-1”.

When one or more vertex indices belonging to the set 3 are included in the vertex indices recorded in one or more of the elements 1 to 3 of the vertex reference array of a surface shown in FIG. 14, the largest one of the one or more vertex indices is copied to the corresponding one or more of the vertex references 3-1 to 3-3. For example, because there is no vertex index belonging to the set 3 in the element 1 of the vertex reference array of FIG. 14, “−1” is recorded in the vertex reference 3-1 of the surface whose surface index is “1-1”. Further, “3-1” recorded in the element 2 of the vertex reference array of FIG. 14 is copied to the vertex reference 3-2, and “3-3” recorded in the element 3 of the vertex reference array of FIG. 14 is copied to the vertex reference 3-3.

The data storage unit 14 of the pre-processing unit 1 carries out a process of storing the divided data of the vertex data and the divided data of the surface data which are outputted from the sorting unit 13 in the HDD 2. More specifically, the data storage unit 14 records the vertex data and the surface data in units of a set which are outputted from the sorting unit 13 in the HDD 2 separately as a unit of storage. By thus recording each set of the vertex data and the surface data as one logical unified object such as a file, when randomly accessing each set currently being recorded in the HDD 2, the run time processing unit 3 can read the set within a fixed time period in the same way.

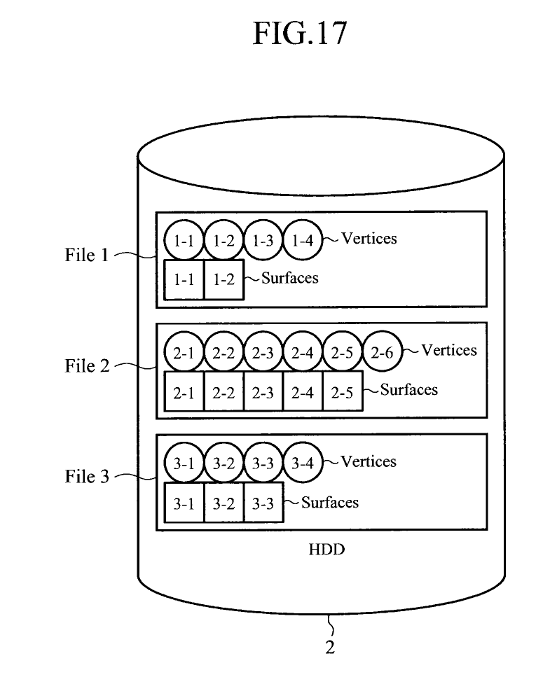

FIG. 17 is an explanatory drawing showing an example in which the vertex data and the surface data belonging to the set 1 are recorded in the HDD 2 as a file 1, the vertex data and the surface data belonging to the set 2 are recorded in the HDD 2 as a file 2, and the vertex data and the surface data belonging to the set 3 are recorded in the HDD 2 as a file 3. In FIG. 17, a numeral in each ◯ shows a vertex index, and the data about the vertex to which the vertex index is added (one row of data shown in FIG. 15) are recorded in a file. Further, a numeral in each □ shows a surface index, and the data about the surface to which the surface index is added (one row of data shown in FIG. 16) are recorded in a file. Although only the data about one of the plurality of polygon models divided in units of a block by the model dividing unit 11 are shown in FIG. 17, the data about all the blocks are actually recorded in the HDD 2.

After the pre-processing unit 1 completes the recording process of recording the vertex data and the surface data, the data expanding unit 31 of the run time processing unit 3 carries out a process of reading the vertex data and the surface data specified by a read command outputted from the polygon model constructing unit 33 from among the vertex data and the surface data recorded in units of a set in the HDD 2. In this stage, the read command outputted from the polygon model constructing unit 33 is the one for commanding the data expanding unit to read the vertex data and the surface data belonging to the set 1, and the data expanding unit carries out a process of reading the vertex data and the surface data belonging to the set 1 from the HDD 2.

Although will be mentioned later in detail, when it is impossible to construct a polygon model having a number of vertices whose number corresponds to the degree of detail determined by the degree of detail determining unit 32 only from the vertex data and the surface data belonging to the set 1, a read command for commanding the data expanding unit to read the vertex data and the surface data belonging to the set 2 or a read command for commanding the data expanding unit to read the vertex data and the surface data belonging to the set 3 can be further outputted from the polygon model constructing unit 33. When receiving the read command for commanding the data expanding unit to read the vertex data and the surface data belonging to the set 2 from the polygon model constructing unit 33, the data expanding unit 31 carries out a process of reading of the vertex data and the surface data belonging to the set 2 from the HDD 2. When receiving the read command for commanding the data expanding unit to read the vertex data and the surface data belonging to the set 3 from the polygon model constructing unit 33, the data expanding unit 31 carries out a process of reading of the vertex data and the surface data belonging to the set 3 from the HDD 2.

After reading the vertex data and the surface data belonging to the set 1 from the HDD 2 in the above-mentioned way, the data expanding unit 31 expands the vertex data and the surface data belonging to the set 1 in the memory 4 from and in which data can be read and written at a higher speed than data are read and written from and in the HDD 2. Although will be mentioned later in detail, when receiving a discard command from the polygon model constructing unit 33, the data expanding unit 31 discards the vertex data and the surface data specified by the discard command from the vertex data and the surface data expanded in the memory 4.

When the visual point information showing a point of view in the virtual space is provided thereto, for each of the polygon models acquired by the model dividing unit 11 of the pre-processing unit 1, the degree of detail determining unit 32 of the run time processing unit 3 determines the degree of detail of drawing of the polygon model in question in consideration of the point of view in the virtual space shown by the visual point information. More specifically, the degree of detail determining unit 32 uses, as a determination criterion, whether or not each of the polygon models divided is located at a position where the polygon model in question can be seen from the point of view in the virtual space, the distance from the point of view in the virtual space to each of the polygon models divided, or whether each of the polygon models divided constructs a part of the outline of the original polygon model yet to be divided (i.e. the polygon model provided to the pre-processing unit 1) when the divided polygon model in question is viewed from the point of view in the virtual space to calculate the contribution of an image of each of the polygon models divided to an image of the original polygon model yet to be divided, and determines the degree of detail of drawing of each of the polygon models in such a way that the higher degree of contribution to the image of the original polygon model yet to be divided the image of the polygon model in question has, the higher degree of detail of drawing the polygon model in question has.

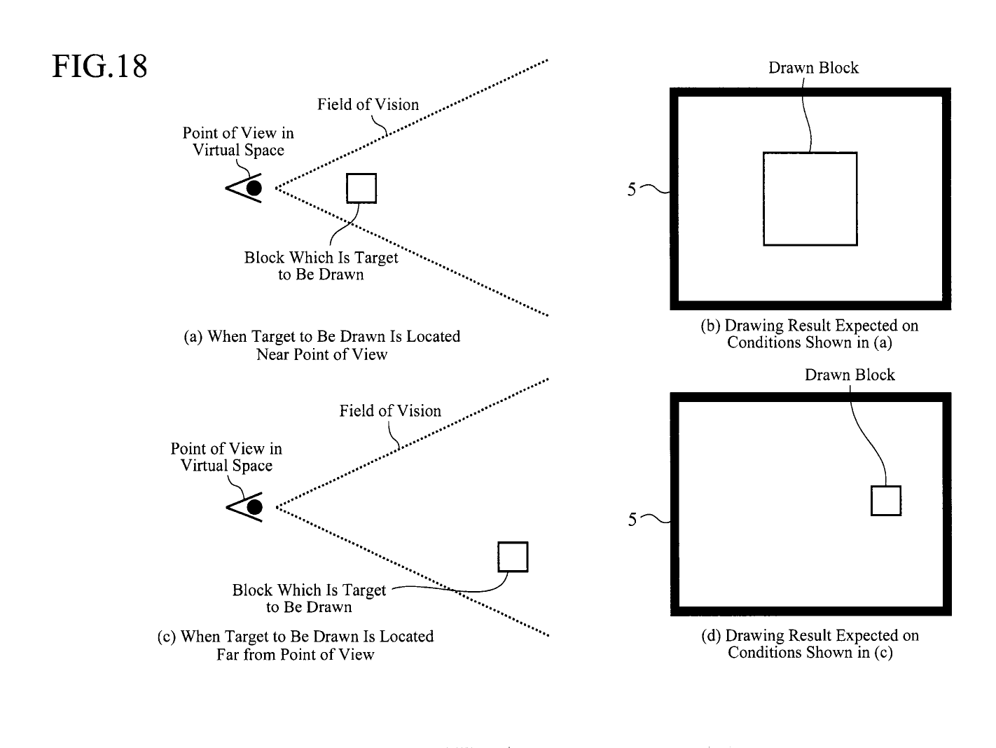

FIG. 18 is an explanatory drawing explaining the determining process of determining the degree of detail of drawing which is carried out by the degree of detail determining unit 32. For example, in a case of drawing a three-dimensional virtual space by using a perspective projection, when a block which is a target to be drawn exists at a position near the point of view in the virtual space, as shown in FIG. 18(a) (when the distance between the block and the point of view in the virtual space is short), an image of the block which is a target to be drawn is drawn in a large size, as shown in FIG. 18(b). Therefore, because the image of the block which is a target to be drawn has a large contribution to the result of drawing of all the blocks (the polygon model provided to the pre-processing unit 1), the result of drawing of all the blocks degrades greatly unless the image of the block which is a target to be drawn is drawn in detail. Therefore, the degree of detail determining unit determines the degree of detail of drawing of the block which is a target to be drawn in such a way that the nearer position from the point of view in the virtual space the block is located at the higher degree of detail of drawing the block has, thereby increasing the number of vertices of the polygon included in the block.

In contrast, when the block which is a target to be drawn exists at a position far from the point of view in the virtual space, as shown in FIG. 18(c) (when the distance between the block and the point of view in the virtual space is long), the image of the block which is a target to be drawn is drawn in a small size, as shown in FIG. 18(d). Therefore, because the image of the block which is a target to be drawn has a small contribution to the result of drawing of all the blocks (the polygon model provided to the pre-processing unit 1), the result of drawing of all the blocks does not degrade greatly even though the image of the block which is a target to be drawn is drawn roughly. Therefore, the degree of detail determining unit determines the degree of detail of drawing of the block which is a target to be drawn in such a way that the farther position from the point of view in the virtual space the block is located at the lower degree of detail of drawing the block has, thereby decreasing the number of vertices of the polygon included in the block.

Although in the example of FIG. 18, the degree of detail determining unit 32 uses, as the determination criterion, the distance from the point of view in the virtual space to the block which is a target to be drawn to determine the degree of detail of drawing of the block (determines a value inversely proportional to the distance from the point of view to the block as the degree of detail of drawing of the block), as previously shown, this embodiment is not limited to this example. For example, the degree of detail determining unit 32 uses, as the determination criterion, whether or not the block which is a target to be drawn is located at a position where the block can be seen from the point of view in the virtual space to determine the degree of detail of drawing of the block. More specifically, because the image of the block which is a target to be drawn has a large contribution to the result of drawing of all the blocks (the polygon model provided to the pre-processing unit 1) when the block which is a target to be drawn is located at a position where the block can be seen from the point of view in the virtual space, the result of drawing of all the blocks degrades greatly unless the image of the block which is a target to be drawn is drawn in detail. In contrast, when the block which is a target to be drawn is located at a position where the block cannot be seen from the point of view in the virtual space, the image of this block has no contribution to the result of drawing of all the blocks (the polygon model provided to the pre-processing unit 1).

Therefore, when the block which is a target to be drawn is located at a position where the block can be seen from the point of view in the virtual space, the degree of detail determining unit determines the degree of detail of drawing of the block to be a high value to increase the number of vertices of the polygon included in the block. In contrast, when the block which is a target to be drawn is not located at a position where the block can be seen from the point of view in the virtual space, the degree of detail determining unit determines the degree of detail of drawing of the block to be a low value (or zero) to decrease the number of vertices of the polygon included in the block.

As an alternative, the degree of detail determining unit can use, as the determination criterion, whether or not the block which is a target to be drawn is obstructed by another block when the block is viewed from the point of view in the virtual space to determine the degree of detail of drawing of the block. In a case in which the block which is a target to be drawn is not obstructed by another block when the block is viewed from the point of view in the virtual space, the block can be viewed as long as the block exists in the field of vision. Therefore, because the image of the block has a large contribution to the result of drawing of all the blocks (the polygon model provided to the pre-processing unit 1), the result of drawing of all the blocks degrades greatly unless the image of the block which is a target to be drawn is drawn in detail. In contrast, in a case in which the block which is a target to be drawn is obstructed by another block when the block is viewed from the point of view in the virtual space, the block cannot be viewed. Therefore, the image of the block has no contribution to the result of drawing of all the blocks.

Therefore, in a case in which the block which is a target to be drawn is not obstructed by another block when the block is viewed from the point of view in the virtual space, the degree of detail determining unit determines the degree of detail of drawing of the block to be a high value to increase the number of vertices of the polygon included in the block. In contrast, in a case in which the block which is a target to be drawn is obstructed by another block when the block is viewed from the point of view in the virtual space, the degree of detail determining unit determines the degree of detail of drawing of the block to be a low value (or zero) to decrease the number of vertices of the polygon included in the block.

As an alternative, the degree of detail determining unit can use, as the determination criterion, whether the block which is a target to be drawn constructs a part of the outline of all the blocks (i.e. the polygon model provided to the pre-processing unit 1) when the block is viewed from the point of view in the virtual space to determine the degree of detail of drawing of the block. Because the image of the block which is a target to be drawn has a large contribution to the result of drawing of all the blocks in a case in which the block which is a target to be drawn constructs a part of the outline of all the blocks when viewed from the point of view in the virtual space (the contribution increases in the case in which the block constructs a part of the outline because the shape of the polygon model changes as the outline changes), the result of drawing of all the blocks degrades greatly unless the image of the block which is a target to be drawn is drawn in detail. In contrast, because the image of the block which is a target to be drawn has a small contribution to the result of drawing of all the blocks in a case in which the block which is a target to be drawn does not construct a part of the outline of all the blocks when viewed from the point of view in the virtual space, the result of drawing of all the blocks does not degrade greatly even though the image of the block which is a target to be drawn is drawn roughly.

Therefore, in the case in which the block which is a target to be drawn constructs a part of the outline of all the blocks when viewed from the point of view in the virtual space, the degree of detail determining unit determines the degree of detail of drawing of the block to be a high value to increase the number of vertices of the polygon included in the block. In contrast, in the case in which the block which is a target to be drawn does not construct a part of the outline of all the blocks when viewed from the point of view in the virtual space, the degree of detail determining unit determines the degree of detail of drawing of the block to be a low value to decrease the number of vertices of the polygon included in the block.

The degree of detail determining unit can alternatively use, as the determination criterion by which to determine the degree of detail of drawing of the block, the traveling speed of the block or the point of view, or the like. The degree of detail determining unit can incorporate various determination criteria, thereby improving the accuracy of estimation of the contribution of the image of each block to the image of all the blocks.

After the degree of detail determining unit 32 determines the degree of detail of drawing of each of the blocks, the polygon model constructing unit 33 of the run time processing unit constructs a polygon model which is a target to be drawn by updating the active flags of the vertex data and the surface data expanded in the memory 4 in such a way that the number of vertices in the polygon model included in each of the blocks into which the original polygon model is divided by the model dividing unit 11 is equal to the number of vertices corresponding to the degree of detail drawing of the block determined by the degree of detail determining unit 32. Hereafter, the processing carried out by the polygon model constructing unit 33 will be explained concretely.

The polygon model constructing unit 33 repeatedly carries out the following process on each of the blocks into which the original polygon model is divided by the model dividing unit 11 to carry out the same process on all the blocks. The polygon model constructing unit 33 grasps the number of active vertices of an arbitrary block expanded in the memory 4 by making reference to the vertex data of the block, and determines whether or not the number of active vertices is equal to the number of vertices corresponding to the degree of detail determined by the degree of detail determining unit 32. The polygon model constructing unit 33 outputs a read command for commanding reading of the vertex data and the surface data belonging to the set 1 to the data expanding unit 31 first, as mentioned above, to cause the vertex data and the surface data belonging to the set 1 to be expanded in the memory 4. However, at this time, it is assumed that because the required number of active vertices is short by the number of vertices corresponding to the degree of detail determined by the degree of detail determining unit 32 by using only the vertex data belonging to the set 1, a read command for commanding reading of the vertex data and the surface data belonging to the set 2 has been also outputted to the data expanding unit 31, and the vertex data and the surface data belonging to the set 2 have been expanded in the memory 4.

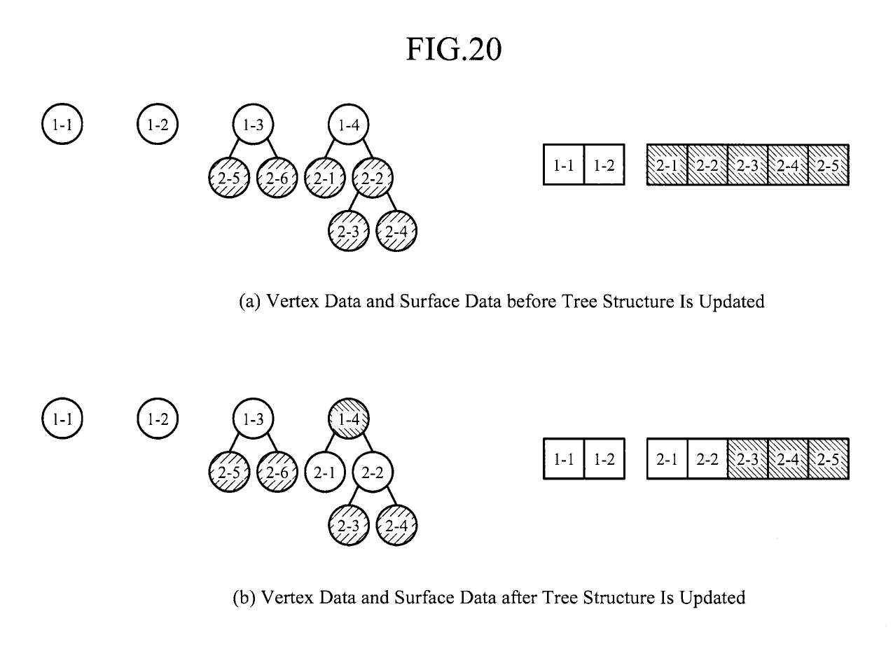

FIG. 20 is an explanatory drawing showing the vertex data and the surface data belonging to the sets 1 and 2 expanded in the memory 4. In FIG. 20, each ◯ shows a vertex of the polygon model, and each □ [symbol] shows a surface of the polygon model. Further, each active vertex and each active surface are filled with white, and each inactive vertex and each inactive surface are filled with hatch lines.

Because the number of active vertices is four in an example of FIG. 20(a), the polygon model constructing unit determines that the number of active vertices is equal to the number of vertices corresponding to the degree of detail when the number of vertices corresponding to the degree of detail determined by the degree of detail determining unit 32 (the higher degree of detail determined by the degree of detail determining unit 32 the block has, the larger number of vertices the block has (i.e. the number of vertices is proportional to the degree of detail)) is four. In contrast, when the number of vertices corresponding to the degree of detail determined by the degree of detail determining unit 32 is not four, the polygon model constructing unit determines that the number of active vertices is not equal to the number of vertices corresponding to the degree of detail.

After determining that the number of active vertices is not equal to the number of vertices corresponding to the degree of detail, the polygon model constructing unit 33 updates the active flags of the vertex data and the surface data expanded in the memory 4 in such a way that the number of active vertices becomes equal to the number of vertices corresponding to the degree of detail (step ST21 of FIG. 19). For example, because the number of active vertices is short by one when the number of vertices corresponding to the degree of detail is five, the polygon model constructing unit increases the number of active vertices by one to cause the number of active vertices to become equal to the number of vertices corresponding to the degree of detail, as shown in FIG. 20(b).

An update from the example shown in FIG. 20(a) to that shown in FIG. 20(b) is carried out according to the following procedure. First, the polygon model constructing unit 33 searches through the active vertices for a vertex to which a child node to which the smallest vertex index is added is connected, and changes the vertex to an inactive one. In the example of FIG. 20(a), the polygon model constructing unit changes a vertex whose vertex index is “1-4” to which a vertex whose vertex index is “2-1” is connected to an inactive vertex. Next, the polygon model constructing unit 33 changes the child nodes connected to the vertex whose vertex index is “1-4” (i.e. the vertices whose vertex indices are “2-1” and “2-2”) to active ones to increase the total number of active vertices by one. The polygon model constructing unit determines whether or not a vertex index is larger than another vertex index by making a comparison between their set indices first, and, when their set indices are equal, making a comparison between the in-set vertex indices.

After changing the vertex whose vertex index is “1-4” to an inactive one, the polygon model constructing unit 33 changes each corresponding surface to an active surface by making reference to the related surfaces of the vertex which has been changed to inactive, and then updating the active flag of the corresponding surface. In the example of FIG. 20(b), the polygon model constructing unit 33 changes the surfaces whose surface indices are “2-1” and “2-2” to active surfaces. Although the example in which the number of active vertices is caused to become equal to the number of vertices corresponding to the degree of detail by increasing the number of active vertices by one is shown above, when the number of vertices corresponding to the degree of detail is six or more, the number of active vertices is further increased and is updated in such a way as to become equal to the number of vertices corresponding to the degree of detail. However, because the number of active vertices cannot be increased any more when the number of active vertices becomes a maximum (when all the active vertices are vertices to each of which no child node is connected) even though the number of active vertices is short of the number of vertices corresponding to the degree of detail, the polygon model constructing unit ends the update process of updating the active flags.

Although the example in which the number of active vertices is increased is shown up to now, when the number of active vertices is larger than the number of vertices corresponding to the degree of detail, the number of active vertices is decreased and is caused to become equal to the number of vertices corresponding to the degree of detail. For the sake of simplicity, it is assumed that FIG. 20(b) shows the vertex data and the surface data yet to be updated and FIG. 20(a) shows the updated vertex data and the updated surface data. It is further assumed that the number of vertices corresponding to the degree of detail is four.

An update from the example shown in FIG. 20(b) to that shown in FIG. 20(a) is carried out according to the following procedure. First, the polygon model constructing unit 33 searches through the active vertices for a vertex to which its parent node is connected and which has the largest vertex index, and changes the vertex to an inactive one. In the example of FIG. 20(b), the polygon model constructing unit changes vertices whose vertex indices are “2-1” and “2-2” to inactive ones. Next, the polygon model constructing unit 33 changes the parent node (i.e. the vertex whose vertex index is “1-4”) which is connected to the vertices whose vertex indices are “2-1” and “2-2” to an active one to decrease the total number of active vertices by one.

After changing the vertex whose vertex index is “1-4” to an active one, the polygon model constructing unit 33 changes the corresponding surfaces to inactive surfaces by making reference to the related surfaces of the vertex which has been changed to active, and updating the active flags of the corresponding surfaces. In the example of FIG. 20(b), the polygon model constructing unit changes the surfaces whose surface indices are“2-1” and “2-2” to inactive surfaces. Although the example in which the number of active vertices is caused to become equal to the number of vertices corresponding to the degree of detail by decreasing the number of active vertices by one is shown above, when the number of vertices corresponding to the degree of detail is three or less, the number of active vertices is decreased and is updated in such a way as to become equal to the number of vertices corresponding to the degree of detail. However, because the number of active vertices cannot be decreased any more when the number of active vertices becomes a minimum (when all the active vertices are vertices to each of which no parent node is connected) even though the number of active vertices is larger than the number of vertices corresponding to the degree of detail, the polygon model constructing unit ends the update process of updating the active flags.

When the number of active vertices greatly differs from the number of vertices corresponding to the degree of detail determined by the degree of detail determining unit 32, the polygon model constructing unit can carry over a part of the update process of updating the active flags to the next process without carrying out the update process at a time because the amount of information to be processed may increase or a deformation of an object may appear remarkably in the image outputted when repeatedly carrying out the update process of updating the active flags in the one-time process of step ST21 until the number of active vertices greatly becomes equal to the number of vertices corresponding to the degree of detail.

After carrying out the update process of updating the active flags of the vertex data and the surface data which are expanded in the memory 4, the polygon model constructing unit 33 determines whether the vertex data and the surface data which are expanded in the memory 4 have an appropriate data volume (step ST22). For example, when the number of active vertices is smaller than the number of vertices corresponding to the degree of detail determined by the degree of detail determining unit 32 even though the polygon model constructing unit, in step ST21, carries out the update process until the number of active vertices reaches its maximum, the polygon model constructing unit determines that the vertex data and the surface data which are expanded in the memory 4 have a small data volume. In contrast, for example, when the vertex data and the surface data belonging to the sets 1 and 2 are expanded in the memory 4, and all the active vertices updated belong to the set 1 (in this case, the vertex data and the surface data belonging to the set 2 are excessive data), the polygon model constructing unit determines that the vertex data and the surface data which are expanded in the memory 4 have a large data volume.

When the vertex data and the surface data which are expanded in the memory 4 have an appropriate data volume, the polygon model constructing unit 33 ends the update process on the block, and then carries out the update process on another block similarly. When the data volume of the vertex data and the surface data which are expanded by the memory 4 is insufficient (when it is impossible to construct a polygon model which has the number of vertices corresponding to the degree of detail by using only the vertex data and the surface data which are currently being expanded in the memory 4), the polygon model constructing unit 33 outputs a read command for commanding reading of the vertex data and the surface data belonging to the set 2 to the data expanding unit 31 when the vertex data and the surface data belonging to the set 1 are currently being expanded in the memory 4 (step ST23). As an alternative, when the vertex data and the surface data belonging to the sets 1 and 2 are currently being expanded in the memory 4, the polygon model constructing unit outputs a read command for commanding reading of the vertex data and the surface data belonging to the set 3 to the data expanding unit 31 (step ST23).

In a case in which the data volume of the vertex data and the surface data which are expanded in the memory 4 are too large (when divided data excessive for constructing a polygon model having a number of vertices whose number corresponds to the degree of detail are expanded in the memory 4), and the vertex data and the surface data belonging to the sets 1, 2, and 3 are currently being expanded in the memory 4, the polygon model constructing unit 33 outputs a discard command for commanding discarding of the vertex data and the surface data belonging to the set 3 to the data expanding unit 31 when a polygon model having a number of vertices whose number corresponds to the degree of detail can be constructed by using only the vertex data and the surface data belonging to the sets 1 and 2 (step ST23). In contrast, in a case in which the vertex data and the surface data belonging to the sets 1 and 2 are currently being expanded in the memory 4, the polygon model constructing unit 33 outputs a discard command for commanding discarding of the vertex data and the surface data belonging to the set 2 to the data expanding unit 31 when a polygon model having a number of vertices whose number corresponds to the degree of detail can be constructed by using only the vertex data and the surface data belonging to the set 1 (step ST23).

When determining whether the vertex data and the surface data which are expanded in the memory 4 have an appropriate data volume, the polygon model constructing unit 33 can predict an available remaining amount of the memory 4 and a movement of the point of view, estimate a data volume having a high likelihood of being required in the future, and carry out the determination in consideration of the result of the estimation.

After the polygon model constructing unit 33 updates the active flags and constructs a polygon model, the drawing processing unit 34 of the run time processing unit 3 draws an image of the polygon model (which consist of vertices whose active flags updated by the polygon model constructing unit 33 show that the vertices are targets to be drawn) on, for example, an internal video RAM, and outputs the image to the image display unit 5. Hereafter, the processing carried out by the drawing processing unit 34 will be explained concretely.

The drawing processing unit 34 repeatedly carries out processes of following steps ST32 to ST35 until referring to all the active surfaces in all the blocks (step ST31). When only the surface data belonging to the set 1 are currently being expanded in the memory 4 (refer to FIG. 16), the drawing processing unit 34 refers to the vertex references 1-1 to 1-3 included in the surface data and checks the three vertices which construct the surface of the polygon which is a target to be drawn (step ST32). In contrast, when the surface data belonging to the sets 1 and 2 are currently being expanded in the memory 4, the drawing processing unit refers to the vertex reference 2-1 to 2-3 included in the surface data and checks the three vertices which construct the surface of the polygon which is a target to be drawn (step ST32). In contrast, when the surface data belonging to the sets 1, 2, and 3 are currently being expanded in the memory 4, the drawing processing unit refers to the vertex reference 3-1 to 3-3 included in the surface data and checks the three vertices which construct the surface of the polygon which is a target to be drawn (step ST32).

However, because no reference destination exists when “−1” is recorded in a vertex reference included in the surface data, the drawing processing unit refers to another vertex reference having a set index smaller than the vertex reference by one (e.g. when referring to the vertex reference 3-1, and “−1” is stored in the vertex reference 3-1, the drawing processing unit refers to the vertex reference 2-1, and, when referring to the vertex reference 2-2, and “−1” is stored in the vertex reference 2-2, the drawing processing unit refers to the vertex reference 1-2). For example, in a case in which the vertex data and the surface data as shown in FIG. 20(a) are expanded in the memory 4, the drawing processing unit refers to the vertex references 1-1, 1-2, and 2-3 with the surface which is an active surface and whose surface index is “1-1” being a target to be drawn (although the surface data belonging to the sets 1 and 2 are expanded, the drawing processing unit refers to the vertex references 1-1 and 1-2 because “−1” is stored in each of the vertex references 2-1 and 2-2), and checks that the three vertices which construct the surface of the polygon which is a target to be drawn are the ones whose vertex indices are “1-1”, “1-2”, and “2-4”.

After checking the three vertices which construct the surface of the polygon which is a target to be drawn, the drawing processing unit 34 refers to the active flags of the three vertices (refer to FIG. 15), and determines whether or not all of the three vertices are active ones (step ST33). When an inactive vertex is included in the three vertices which construct the surface of the polygon which is a target to be drawn, the drawing processing unit 34 refers to the active flag of the vertex corresponding to the parent node of the inactive vertex (step ST34), and determines whether or not the vertex is an active one (step ST33).

In the example of FIG. 20(a), because the vertex whose vertex index is “2-4” is inactive, the drawing processing unit refers to the active flag of the vertex corresponding to the parent node of the vertex (the vertex whose vertex index is “2-2”). Because the vertex whose vertex index is “2-2” is inactive, the drawing processing unit refers to the active flag of the vertex corresponding to the parent node of the vertex (the vertex whose vertex index is “1-4”). Because the vertex whose vertex index is “1-4” is active, the drawing processing unit shifts to a process of step ST35. In contrast, because the vertex whose vertex index is “2-2” is active when the vertex data and the surface data which are currently being expanded in the memory 4 are updated from those shown in FIG. 20(a) to those shown in FIG. 20(b), the drawing processing unit shifts to the process of step ST35 without referring to the active flag of the vertex whose vertex index is “1-4”.

After finding out three active vertices (the vertices whose vertex indices are “1-1”, “1-2”, and “1-4” in the case in which the vertex data and the surface data which are currently being expanded in the memory 4 are as shown in FIG. 20(a), or the vertices whose vertex indices are “1-1”, “1-2”, and “2-2” in the case in which the vertex data and the surface data which are currently being expanded in the memory 4 are updated from those shown in FIG. 20(a) to those shown in FIG. 20(b)) in the above-mentioned way, the drawing processing unit 34 refers to the position information included in the vertex data to determine the three dimensional position (X, Y, Z) of each of the three active vertices, and uses the three dimensional position (X, Y, Z) to draw a triangular polygon which consists of the three active vertices on, for example, the internal video RAM (step ST35).

After drawing all the polygons each of which consists of active vertices by making reference to all the active surfaces in all the blocks (step ST31), the drawing processing unit 34 outputs the image of the polygon model (the polygon model provided to the pre-processing unit 1) which is the result of the drawing to the image display unit 5 (step ST36). As a result, the image of the polygon model is displayed on the image display unit 5. The process of drawing the image from both the three-dimensional positions of the polygons and the positional attitude of the point of view can be implemented by using arbitrary processes used for typical polygon drawing.

As can be seen from the above description, the image display device in accordance with this Embodiment 1 includes the model dividing unit 11 for dividing a polygon model expressing a three-dimensional object, the data creating unit 12 for, for each of polygon models into which the original polygon model is divided by the model dividing unit, creating new vertices from existing vertices of one or more polygons which construct the polygon model in question to create vertex data in which a logical connection relation between vertices of one or more polygon models including the new vertices is expressed by a tree structure, the sorting unit 13 for dividing the vertex data created by the vertex data creating unit 12 into a plurality of divided data and for outputting the plurality of divided data of the vertex data, the data storage unit 14 for storing the plurality of divided data of the vertex data outputted from the sorting unit 13 in the HDD 2, the data expanding unit 31 for reading divided data specified by a read command from among the plurality of divided data stored in the HDD 2 and expanding the divided data in the memory 4 from and in which data can be read and written at a higher speed than data are read and written from and in the HDD 2, and for discarding divided data specified by a discard command from the divided data expanded in the memory 4, the degree of detail determining unit 32 for determining the degree of detail of drawing of each of the polygon models into which the original polygon model is divided by the model dividing unit 11 in consideration of a point of view in a virtual space, and the polygon model constructing unit 33 for referring to the divided data expanded in the memory 4 and constructing a polygon model having a number of vertices whose number corresponds to the degree of detail determined by the degree of detail determining unit 32, and for outputting a read command specifying divided data to be read and a discard command specifying divided data to be discarded to the data expanding unit 31, and the drawing unit 34 draws the polygon model constructed by the polygon model constructing unit 34. Therefore, there is provided an advantage of being able to draw a complicated three-dimensional virtual environment at a high speed and with a high degree of quality by applying an LOD technique to the image display device even though no storage unit from and in which a lot of data can be read and written at a high speed is mounted in the image display device.

More specifically, because the image display device in accordance with this Embodiment 1 is constructed in such a way that the data expanding unit 31 expands only a required part of the plurality of divided data (the vertex data and surface data stored in units of a set) of all the vertex and surface data which are stored in the large-volume HDD 2 (i.e. the data required to be able to construct a polygon model having a number of vertices whose number corresponds to the degree of detail of drawing) in the memory 4 according to a command from the polygon model constructing unit 33, there is provided an advantage of being able to greatly reduce the amount of consumption of the memory 4 as compared with the case of using Progressive Mesh which is a conventional technique.

Although in this Embodiment 1 the example in which the polygon model provided to the pre-processing unit 1 includes the vertex data including the position information showing the three dimensional position (X, Y, Z) of each vertex, and the surface data including the vertex information showing the vertices which construct the surface of each polygon is shown, the vertex data and the surface data can additionally have information available when drawing an image, such as the normal to each vertex and the normal to each surface, and a texture used to fill each surface.

### INDUSTRIAL APPLICABILITY

The present invention is suitable for an image display device which can use three-dimensional geometrical information to draw a complicated three-dimensional virtual environment at a high speed and with a high degree of quality.

1. An image display device comprising:
a model dividing unit for dividing a polygon model expressing a three-dimensional object;
a vertex data creating unit for, for each of polygon models into which the polygon model is divided by said model dividing unit, creating new vertices from existing vertices of one or more polygons which construct said each polygon model to create vertex data in which a logical connection relation between vertices of one or more polygon models including the new vertices is expressed by a tree structure;
a data storage unit for dividing the vertex data created by said vertex data creating unit into a plurality of divided data to store the plurality of divided data of said vertex data in a storage unit;
a data expanding unit for reading divided data specified by a read command from among the plurality of divided data stored in said storage unit and expanding said divided data in a recording medium from and in which data can be read and written at a higher speed than data are read and written from and in said storage unit, and for discarding divided data specified by a discard command from the divided data expanded in said recording medium;
a degree of detail determining unit for determining a degree of detail of drawing of each of the polygon models into which said polygon model is divided by said model dividing unit in consideration of a point of view in a virtual space;
a polygon model constructing unit for referring to the divided data expanded in said recording medium and constructing a polygon model having a number of vertices whose number corresponds to the degree of detail determined by said degree of detail determining unit, and for outputting a read command specifying divided data to be read and a discard command specifying divided data to be discarded to said data expanding unit; and
a drawing unit for drawing the polygon model constructed by said polygon model constructing unit.

2. The image display device according to claim 1, wherein for each vertex of the one or more polygon models including the new vertices, the vertex data creating unit creates the vertex data including information showing a three dimensional position of said each vertex, information showing vertices each having a logical connection relation with said each vertex, an active flag showing whether or not said each vertex is a target to be drawn.

3. The image display device according to claim 1, wherein the data storage unit stores each divided data of the vertex data in said storage unit separately as a unit of storage.

4. The image display device according to claim 1, wherein the degree of detail determining unit calculates a contribution of an image of each of the polygon models divided to an image of the polygon model yet to be divided by the model dividing unit in consideration of the point of view in the virtual space to determine the degree of detail of drawing of each of the polygon models divided in such a way that a higher degree of contribution the image of each of the polygon models has, a higher degree of detail of drawing each of the polygon models has.

5. The image display device according to claim 4, wherein the degree of detail determining unit uses, as a determination criterion, whether or not each of the polygon models divided by said model dividing unit is located at a position where the polygon model can be seen from the point of view in the virtual space, a distance from the point of view in the virtual space to each of the polygon models divided, or whether each of the polygon models divided constructs a part of an outline of the polygon model yet to be divided when said each of the polygon models divided is viewed from the point of view in the virtual space to calculate the contribution of the image of each of the polygon models divided to the image of the polygon model yet to be divided.

6. The image display device according to claim 2, wherein the polygon model constructing unit constructs the polygon model which is a target to be drawn by updating active flags included in vertex data and surface data expanded in the recording medium in such a way that the number of vertices in each of the polygon models divided by said model dividing unit is equal to the number of vertices corresponding to the degree of detail determined by the degree of detail determining unit.

7. The image display device according to claim 1, wherein when it is impossible to construct the polygon model having a number of vertices whose number corresponds to the degree of detail determined by the degree of detail determining unit by using only the divided data currently being expanded in the recording medium, the polygon model constructing unit outputs a read command for commanding reading of other divided data to the data expanding unit, and, when divided data excessive for the construction of the polygon model having a number of vertices whose number corresponds to the degree of detail determined by said degree of detail determining unit are expanded in said recording medium, said polygon model constructing unit outputs a command for commanding discarding of the excessive divided data to said data expanding unit.
